(19) United States
(12) Patent Application Publication
(10) Pub. No.: US 2009/0125549 A1
(43) Pub. Date: May 14, 2009

(54) METHOD AND SYSTEM FOR CALCULATING COMPETITIVENESS METRIC BETWEEN OBJECTS

(75) Inventors: Jianqiang LI, Beijing (CN); Yu ZHAO, Beijing (CN); Toshikazu FUKUSHIMA, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (CHINA) CO., LTD., Beijing (CN)

(21) Appl. No.: 12/268,866

(22) Filed: Nov. 11, 2008

(30) Foreign Application Priority Data
Nov. 13, 2007 (CN) 200710188234.3

(51) Int. Cl. G06F 17/30

(52) U.S. Cl. 707/103 R; 707/E17.055

(57) ABSTRACT

Method and System for calculating competitiveness metric between objects are provided. The method comprises the steps of: obtaining a first object and a second object; selecting, from all the relation instances stored in a relation instance repository, associated relation instances related to the first and second objects; and calculating, based on the selected associated relation instances, an extensional competitiveness metric Sₒᵤₜ between the first and second objects as the competitiveness metric between the first and second objects. In an embodiment, the frequency that the associated relation instances related to the first and second objects appear in all the information source documents can be used for characterizing the extensional competitiveness metric. Furthermore, the present invention also provides an integrated competitiveness metric calculation method and system for combining the intensional and extensional competitiveness analysis results.

### FIELD OF THE INVENTION

This invention relates to information processing, and more particularly, to provide a method and system for calculating competitiveness metric between two objects (e.g., products/companies) to allow automatic competitor mining/finding.

### BACKGROUND

At present, the amount of information that people can acquire is increasingly rising. Due to the requirements for the amount of information and the processing time, especially the rapid development of the network and communication technologies, certain information features, such as a large amount of information, varieties of information and decentralization of information, become more and more obvious. In many applications, it is impossible to process information manually. Therefore, it is desirable to use some network and computer technologies, such as information extraction, mining, comparison, measurement, evaluation etc. to process the information. Among these computer technologies, an important information processing technology is to analyze and calculate automatically the competitiveness metric between objects (e.g., products/companies).

In today's competitive environment, particularly in a business scenario, almost every company wants to know who its competitors are, where they are, and what they are doing. However, it is a timing consuming and laborious task to find and watch the competitor, especially, in the globalization environment, where the competitor comes from all over the world and the players and their products in the market are continually changing.

Business Intelligence (BI) represents a broad category of technologies and applications required to turn raw data into information/knowledge and help enterprise users make better business decisions. Competitive Intelligence (CI), which is narrower in scope than BI, focuses specifically on gathering, analyzing, and managing information about the external business environment. Although these research/business disciplines have been established for a long time, currently the competitive information can only be obtained from three ways, i.e., 1) through field research interviews or networking with competitor staff or customers; 2) collecting the necessary information with the help of web search engine (e.g., Google) and the results are browsed and summarized by human; 3) from public or subscription sources, e.g., Yahoo Finance, D&B, infoUSA, Hoovers, and OneSource. 1) and 2) are totally based on human's activities/efforts, it is laborious and time consuming, and also the collected information scope is restricted. As for 3), there might be some commercial databases that comprise company information, however, their data scale is very limited, which means that most of them are in single language, includes only financial information (e.g., Yahoo Finance and D&B), or covers only local companies (e.g., infoUSA). In addition, since the information in these commercial databases is updated by human, it is difficult or even impossible to enable the subscriber/user to harvest real-time competitiveness relevant information in a large-scale way, especially in the global business environment.

Considering that the task of finding and watching the competitor is very laborious for human being, more efficient ways of competitive analysis are strongly required for computing the competitiveness metric between competitors (e.g. companies/products).

Since the given competitiveness metric computation solutions borrow some ideas from similarity metric computation between two objects (documents/records), the relevant similarity metric computation approaches or solutions are summarized in the following.

Basically, the methods and systems developed for similarity metric computation between two objects can be divided into content-based approach, citation-based approach, and hybrid approach.

For the content-based approach, it can be further classified as Vector Space Model (VSM) based methods and attribute-value based methods. VSM based methods mainly be applied for computing the similarity metric between two full-text documents. Its basic idea is: each document is broken down into a word frequency vector; a vocabulary is built from all the words in all documents in the system; each document is represented as a vector based against the vocabulary; then a specific similarity measures (there are many similarity measures, among which cosine measure calculating the angle between the vectors in a high-dimensional virtual space is the most popular one) is adopted for the measuring how similar two documents are. Attribute-value based similarity scoring methods mainly targets for structural documents/records with fixed and common schema. Similar with VSM based methods, firstly, the document is represented as a vector of attribute-values (each of which describes one aspect of the document/record); secondly, the similarity distance is calculated with respect to each of the attribute-values (during this process, many different similarity measures might be employed); thirdly, the classification of the attributes is conducted based on their contributions to the similarity metrics; finally, the weighting policy is applied to the classified attributes and the document/record similarity is measured as the weighted sum of the similarity of their attribute-values.

For citation-based approach, it computes the similarity metric between two objects (e.g. web documents) based on their hyperlinks/citations information. The hyperlink/citation analysis is conducted for the whole documents (web pages) set, the result of which can improve the result of purely attribute/word-vector-model-based similarity metric computation method.

As for the hybrid approach, the similarity metric between two objects is computed by considering not only the content but also their link structure among all the objects. The basic features for similarity metric computing include the hyperlink structure, the textual information and DOM structure similarity. The similarity weight from link structure is adjusted by the similarities of textual information and DOM structure.

Besides the general solutions for similarity computation, some specific modules in the following patents are also relevant to the invention presented here, and are hereby incorporated entirely by reference for all the purposes:

(1) U.S. Pat. No. 5,731,991;

(2) U.S. Patent No. 20050004880A1;

(3) U.S. Patent No. 20050192930A1; and

(4) U.S. Patent No. 2004068413.

However, with respect to the competitiveness metric calculation, the disadvantages of the above-mentioned existing solutions are described as following.

Firstly, the existing solutions are proposed particularly for similarity computing between two documents/records. However, competitiveness computing is different from similarity computing, although intuitively their purpose (problem) is somewhat the same. Conceptually, competitive relation is a subset of similarity relation, i.e., similarity is a sufficient but unnecessary condition of competition. Two subjects is similar doesn't means that they compete with each other. More specifically, 1) their target objects are different: the relevant prior arts mainly focus on the similarity calculation between two free-text or structural documents/objects, competitiveness computing concerns any two subjects which might compete with each other; 2) their target relations are different: there are differences between definitions of competitiveness and similarity, i.e., the competitive relation means that the existence/development of one object has a negative influence on another object. Then, for measuring the competitiveness strength between two subjects competing with each other, the specific policies with respect to competitiveness are needed.

For the content-based approach, all the current solutions for similarity computing assume that the targeted objects have the same schema (i.e., totally in full-text or with a specific data structure). VSM model-based method can't handle the situation that one of the objects to be compared has structural or semi-structural profile, and the attribute-value based method can't handle the situations that one of the objects to be compared has full-text profile or two objects with heterogeneous structural profile. But, in reality, the objects needed to be compared might come from different information sources (e.g., disparate databases or different websites), which blocks the application of existing solutions. Also, since only the content of the compared objects is considered for the similarity computing (i.e., through intensional semantic analysis), the result of which might not be objective and comprehensive for the reason that the viewpoints from others' explicitly expressed comments are not considered inside.

For the citation-based and hybrid approaches, the hyperlinks/citations indicate the reference or recommendation relation between the source and the destination objects, which can be looked as a kind of implied semantics expressed by others. Then, not only the content of the compared objects but also the link/citation structure among the objects are employed for similarity calculation. However, since the meaning of the hyperlink or citation is not specified explicitly, all this information is utilized in a syntactic way, which can be looked on as implicit extensional semantic analysis. The viewpoints from 3rd parties' comments which are expressed explicitly are not considered inside.

Furthermore, the patents listed above can only be applied for a specific object category with a common and fixed attribute or feature structure. The adopted methods can't be applied for cross category similarity metric computation. In addition, there is no comprehensive comparison between any two objects (e.g. products/companies) to identify their competitive strength. Therefore, no competitiveness metric can be derived with the existing technologies listed above.

### SUMMARY OF THE INVENTION

In view of the above and other deficiencies and disadvantages of the existing methods in the prior art, the present invention is made. The purpose of the present invention is to provide a method and system for obtaining the competitiveness metric between two objects (e.g., products/companies). The present invention has three relevant aspects, i.e. intensional competitiveness metric calculation, extensional competitiveness metric calculation, and integrated (combined) competitiveness metric calculation. Each of them may be a typical embodiment of the competitiveness metric calculation method of the present invention.

The embodiment of the extensional competitiveness metric calculation employs an extensional criterion, i.e., exploiting the competitive relations expressed explicitly by 3rd parties information sources (e.g., news or blogs websites) for competitiveness analysis. Multiple types of relation instances might be extracted from some News or Blogs websites by utilizing certain text mining or information extraction technologies well-known in the art.

According to one aspect of the present invention, it is provided a method for calculating extensional competitiveness metric between objects, which comprises the steps of: obtaining a first object and a second object; selecting, from all the relation instances stored in a relation instance repository, associated relation instances related to the first and second objects; and calculating, based on the selected associated relation instances, an extensional competitiveness metric between the first and second objects. In one embodiment, calculating the extensional competitiveness metric between the first and second objects may comprise calculating a ratio of the number of documents that the associated relation instances related to the first and second objects belong to and the total number of documents that all relation instances stored in the relation instance repository belong to, as the extensional competitiveness metric between the first and second objects.

According to another aspect of the present invention, it is provided a system for calculating extensional competitiveness metric between objects, which comprises: an object obtaining means for obtaining a first object A and a second object B; a relation instance repository for storing relation instances; a relation instance selection means for selecting, from all the relation instances stored in a relation instance repository, associated relation instances related to the first and second objects; and an extensional competitiveness metric calculation means for calculating, based on the selected associated relation instances, an extensional competitiveness metric between the first and second objects. Similarly, the extensional competitiveness metric calculation means may be configured for calculating a ratio of the number of documents that the associated relation instances related to the first and second objects belong to and the total number of documents that all relation instances stored in the relation instance repository belong to, as the extensional competitiveness metric between the first and second objects.

Corresponding to the extensional competitiveness metric calculation, it is also disclosed an intensional competitiveness metric calculation solution in the present invention, which employs an intensional criterion, namely, by comparing object profiles, to measure the competitiveness strength between two objects. In particular, it is provided a method for calculating intensional competitiveness metric between objects, which comprises the steps of: obtaining a first object and a second object, the first and second objects having a first profile and a second profile, each composed of a plurality of attributes, respectively; normalizing the first profile and the second profile with reference to ontology information; and calculating, based on the normalized first and second profiles, an intensional competitiveness metric between the first and second objects. In some cases, the ontology information may be a common attribute name vocabulary, and the profiles of different objects are compared in a direct way to obtain the competitiveness metric. First, the first and second profiles are normalized by using the corresponding ontology information, that is, a unified profile structure is generated by referring to the common attribute name vocabulary, and the respective attributes in the first and second profiles are aligned with the corresponding attributes in the unified profile. Then, the final competitiveness metric can be obtained by calculating a competitiveness sub-metric for each pair of corresponding attributes in the aligned first and second profiles and calculating the weighted sum of the competitiveness sub-metrics. Further, the ontology information may be an object category tree, of which each node represents an object category and includes one or more representative profiles. In such a case, the profiles of different objects are compared in an indirect way to obtain the intensional competitiveness metric. First, the first and second profiles are normalized by using the corresponding ontology information, that is, the first and second profiles are mapped to one or more nodes of the object category tree respectively. Then, the final intensional competitiveness metric can be obtained by referring to the semantic distance between each pair of nodes of the object category tree and the probabilities of mapping the profiles to the corresponding nodes.

Furthermore, in the embodiment of integrated competitiveness metric calculation, the integrated competitiveness metric between two objects (e.g. products/companies) can be generated through the dynamic integration of the results of intensional competitiveness metric calculation and extensional competitiveness metric calculation. To guarantee the final competitiveness metric is objective and comprehensive, firstly, the data quality of the extracted relation instances during the extensional competitiveness metric calculation is analyzed to decide if they are credible or to what extent they are credible, the result of which will be utilized for assignment of weight coefficients used in the integrated competitiveness metric calculation. Then, an adaptive mechanism to combine the extensional competitive metric with the intensional competitive metric for each object pair is adopted to derive the final integrated competitiveness metric, which will reflect not only the result of intensional semantic analysis but also the result of extensional semantic analysis. During this combination process, the inconsistencies that might appear between the intensional and extensional competitiveness metrics can be handled through an adjustable policy, which mainly depends on the temporal related statistical information and the credibility of corresponding information sources.

According to the present invention, the competitiveness metric between two objects (e.g., products/companies) can be calculated, which is a newly defined metric and different from the well-known similarity metric.

Since the extensional competitiveness metric is generated from the relation instances expressed explicitly from 3rd parties (e.g., news or blogs, which are said by others), the resulting competitiveness metric is more objective than the result of intensional competitiveness metric calculation.

Furthermore, in the integrated competitiveness metric calculation, a dynamic mechanism to combine intensional competitiveness metric calculation and the extensional competitiveness metric calculation is provided, through which the quality of the information source can be exploited as much as possible (knowledge provenance analysis). Since the final integrated competitiveness metric reflects not only the similarity of object profiles but also the comments from 3rd parties, the integrated competitiveness analysis can get a more comprehensive result comparing to the absolute intensional competitiveness analysis (content-based competitiveness analysis) or extensional competitiveness analysis methods.

Furthermore, in the extensional or integrated competitiveness metric calculation, besides the competitiveness metric, the time-stamp together with the news/blogs from the Web could be mapped to the relation instance and then to the final competitiveness metric, through which the temporal (time-dependent) analysis of the competitive relation can be supported. Other additional information together with the relation instance might include the locations or industry domains, which can also provide corresponding potential support for certain specific market analysis.

The foregoing and other features and advantages of the present invention can become more obvious from the following description in combination with the accompanying drawings. Please note that the scope of the present invention is not limited to the examples or specific embodiments described herein.

### BRIEF DESCRIPTIONS OF THE DRAWINGS

The foregoing and other features of this invention may be more fully understood from the following description, when read together with the accompanying drawings in which:

FIG. 1 is a structural block diagram of the intensional competitiveness metric calculation system for calculating the intensional competitiveness metric according to the present invention;

FIG. 2 is a flow chart diagram of an example of the operation of the intensional competitiveness metric calculation system shown in FIG. 1;

FIG. 3 is a detailed block diagram of the intensional competitiveness metric calculation system in the direct way, which performs the normalization of the profiles by aligning the attributes according to the common attribute name vocabulary;

FIG. 4 is a flow chart diagram for showing the operation of the system shown in FIG. 3;

FIG. 5 shows an example of the attribute alignment process in the intensional competitiveness metric calculation;

FIG. 6 is a block diagram for showing in more details the competitiveness sub-metric calculating unit in FIG. 3;

FIG. 7 is a block diagram of the competitiveness sub-metric calculating unit in the case of selecting the VSM-based method to compute the sub-metrics of the attributes;

FIG. 8 is a detailed block diagram of the intensional competitiveness metric calculation system in the indirect way, which performs the normalization of the profiles by mapping them to the nodes in the object category tree;

FIG. 9 is a flow chart diagram for showing the operation of the system shown in FIG. 8;

FIG. 10 is a schematic diagram for showing the object category tree and the hierarchy of the representative profiles corresponding to the structure of the nodes in the object category tree;

FIG. 11 shows an example of the process for computing the competitiveness metric by mapping the profiles to the nodes in the object category tree during the intensional competitiveness metric calculation under the indirect mode;

FIG. 12 is a structural block diagram of the extensional competitiveness metric calculation system for calculating the extensional competitiveness metric according to the present invention;

FIG. 13 is a flow chart diagram of an example of the operation of the extensional competitiveness metric calculation system shown in FIG. 12;

FIG. 14 is a detailed block diagram of an example of the extensional competitiveness metric calculation system of the present invention, which shows in more details the internal structure of the extensional competitiveness metric calculating means;

FIG. 15 is a flow chart diagram for showing the operation of the extensional competitiveness metric calculation system shown in FIG. 14 for calculating the extensional competitiveness metric;

FIG. 16 is a detailed block diagram of another example of the extensional competitiveness metric calculation system of the present invention, which incorporates a relation instance filter means for performing temporal, area or domain analysis on the extensional competitiveness strength between objects according to the additional information in the associated relation instances;

FIG. 17 is a structural block diagram of the integrated competitiveness metric calculation system for calculating the integrated competitiveness metric according to the present invention;

FIG. 18 is a detailed block diagram of an example of the combination module in the integrated competitiveness metric calculation system shown in FIG. 17;

FIG. 19 is a flow chart diagram for showing the process of combining the intensional and extensional competitiveness metrics of the combination module shown in FIG. 18; and

FIG. 20 is a schematic block diagram of the computer system that is used to implement the present invention.

### DETAILED DESCRIPTION OF THE PREFERRED EMBODIMENTS

As described above, the competitiveness relation is a newly defined relation, which is different from the well-known similarity relation. In addition, almost all the current solutions for similarity computing in the prior art assume that the targeted objects (i.e. documents/products) have the same schema. For example, VSM-based method cannot handle the situation that one of the subjects to be compared has structural or semi-structural profile, and the attribute-value based method cannot handle the situations that one of the subjects to be compared has full-text profile or two subjects with heterogeneous structural profile, which blocks the application of existing solutions. Due to these facts, it is provided in the present invention a method and system for deriving the competitiveness metric between two objects (e.g. products/companies). Depending on different standards, the present invention has three relevant aspects, i.e. intensional competitiveness metric calculation, extensional competitiveness metric calculation, and integrated (combined) competitiveness metric calculation.

### [Intensional Competitiveness Metric Calculation]

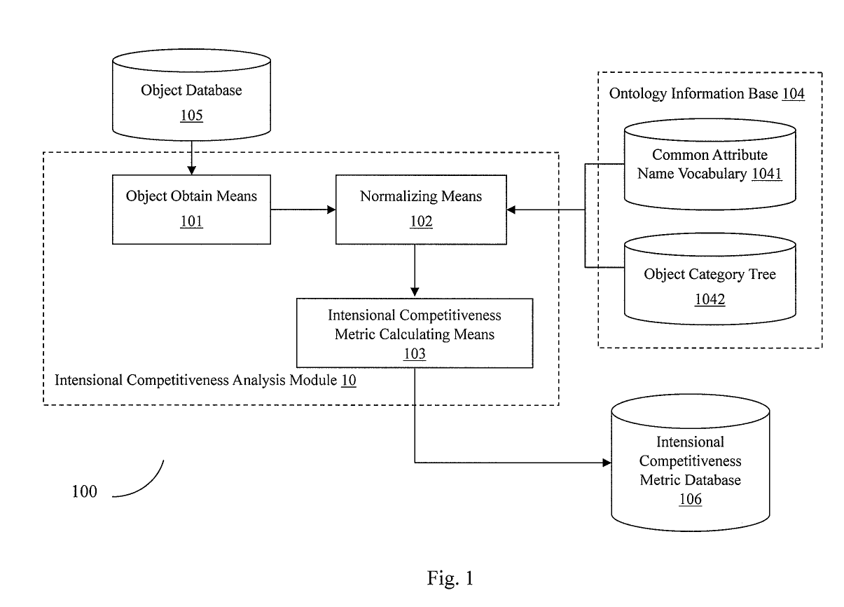

The intensional competitiveness metric calculation is a method for calculating the competitiveness metric between objects based on an intensional standard, namely, by comparing the profiles of different objects to evaluate the competitiveness strength between them. In turn, the intensional competitiveness metric calculation can be classified as a direct method and an indirect method. In the direct method, the object profiles are compared directly after the normalization process to calculate the competitiveness metric. In the indirect method, the object profiles are compared by taking an object category tree as a medium to calculate the competitiveness metric. First, the intensional competitiveness metric calculation will be described below with reference to FIGS. 1-11.

FIG. 1 is a structural block diagram of the intensional competitiveness metric calculation system 100 of the present invention. As shown in FIG. 1, the major part of the system 100 is an intensional competitiveness analysis module 10, which includes an object obtain means 101, a normalizing means 102 and an intensional competitiveness metric calculating means 103. Furthermore, the system 100 further comprises an ontology information base 104, an object database 105 and an intensional competitiveness metric database 106, wherein the object database 105 stores the objects (e.g. product profiles) collected from the Web or other information sources. The ontology information base 104 is configured for storing ontology information (i.e. background knowledge) referred by the competitiveness analysis module 10 for computing the competitiveness metric. The ontology information is a common understanding of the interested domain about the categorization of the subjects in corresponding domain, and can be set up in a manual or (semi-) automatic way in advance. For example, the ontology information may include a common attribute name vocabulary 1041 and an object category tree 1042, which will be described in detail later. The intensional competitiveness metric database 106 is used for storing the calculated intensional competitiveness metric.

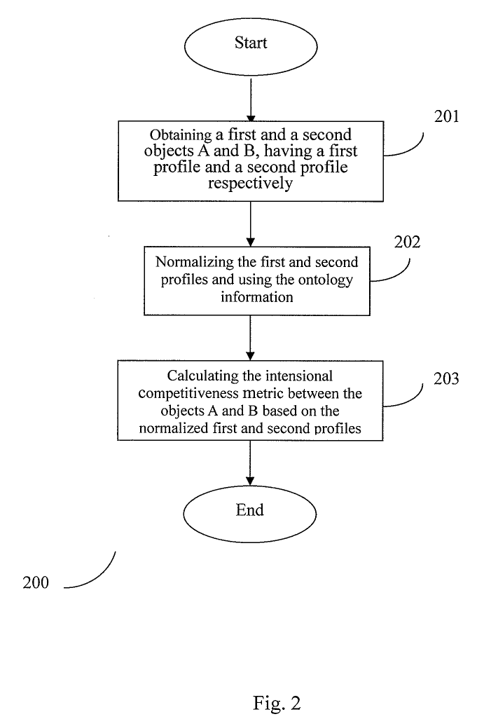

FIG. 2 is a flow chart diagram of an example of the operation of the system 100 shown in FIG. 1. The process begins with step 201 where a first and a second objects to be compared are obtained from the object database 105. The first and second objects are characterized by a first profile A and a second profile B respectively. Since the objects might be collected from multiple sources, even for the same category object, the resulting first and second profiles A and B might be of different structures, such as in full-text or heterogeneous structures. Here, we use a set of attribute-values to specify the resultant profiles, for example, A=(A1-V_{A}1, A2-V_{A}2, . . . , Am-V_{A}m) and B=(B1-V_{B}1, B2-V_{B}2, . . . , Bn-V_{B}n), where Ai is the ith attribute in the profile A, V_{A}i is the value of the ith attribute in the profile A. Similarly, Bi is the ith attribute in the profile B, V_{B}i is the value of the ith attribute in the profile B. Basically, the value is utilized to describe the attribute, which can be a digital number, a mixed string by digital number and English characters (and/or Chinese characters, and/or punctuations), a piece of text, and so on. A full-text profile is treated as a special case of structural profile that it has only one pair of attribute-value. Next, in step 202, the ontology information from the ontology information base 104, such as the common attribute name vocabulary 1041 or the object category tree 1042, is referred to normalize the first profile A and the second profile B so as to facilitate the competitiveness metric computation. As described in detail later, the step of normalizing can be implemented by one of: (1) referring to the common attribute name vocabulary 1041 to determine a unified profile structure and aligning the first and second profiles A and B with the unified profile in their structures (hereinafter, which is referred to as “direct way”); or (2) mapping the first profile A and the second profile B to the object category tree 1042 (hereinafter, which is referred to as “indirect way”). Then, in step 203, the normalized first and second profiles A and B can be used to compute the intensional competitiveness metric between the first and second objects.

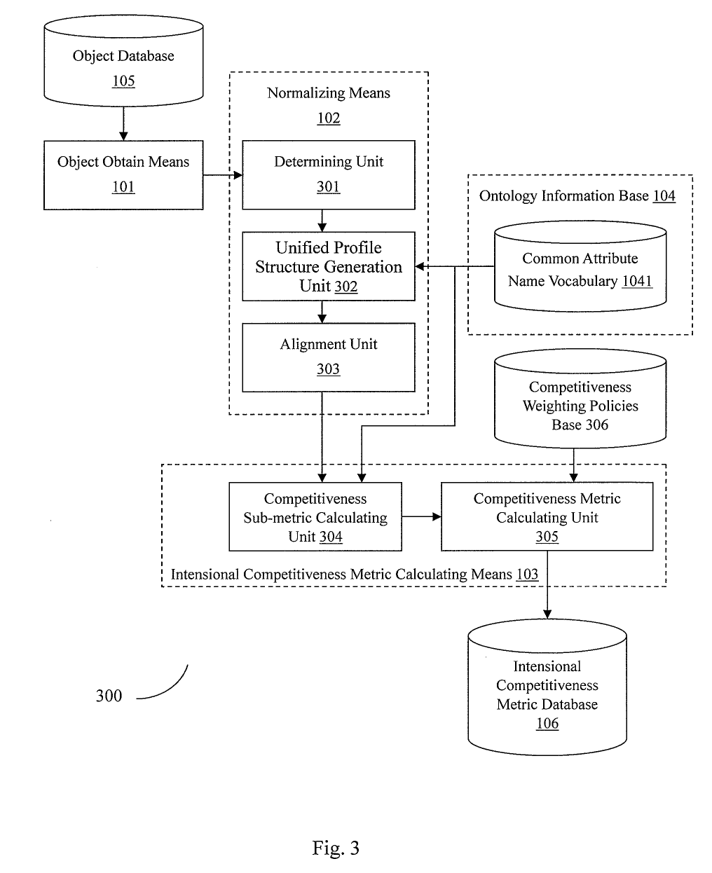

Below, the intensional competitiveness metric calculation in the direct way will be described first with reference to FIGS. 3-7. It should be noted that the described embodiments are only used for the purpose of illustration, and the present invention is not limited to any of the specific embodiments described herein. As shown in FIG. 3, which shows a block diagram of the intensional competitiveness metric calculation system 300 in the direct way, the profiles are normalized by aligning the attributes of the profiles according to the common attribute name vocabulary, namely, in the direct way.

As shown in FIG. 3, in this embodiment, the common attribute name vocabulary 1041 is considered as the ontology information. The normalizing means 102 includes a determining unit 301, a unified profile structure generation unit 302 and an alignment unit 303. The intensional competitiveness metric calculating means 103 includes a competitiveness sub-metric calculating unit 304 and a competitiveness metric calculating unit 305. Furthermore, the system 300 also includes a competitiveness weighting policies base 306 for providing domain-specific competitiveness weighting strategies, which will be described in detail later.

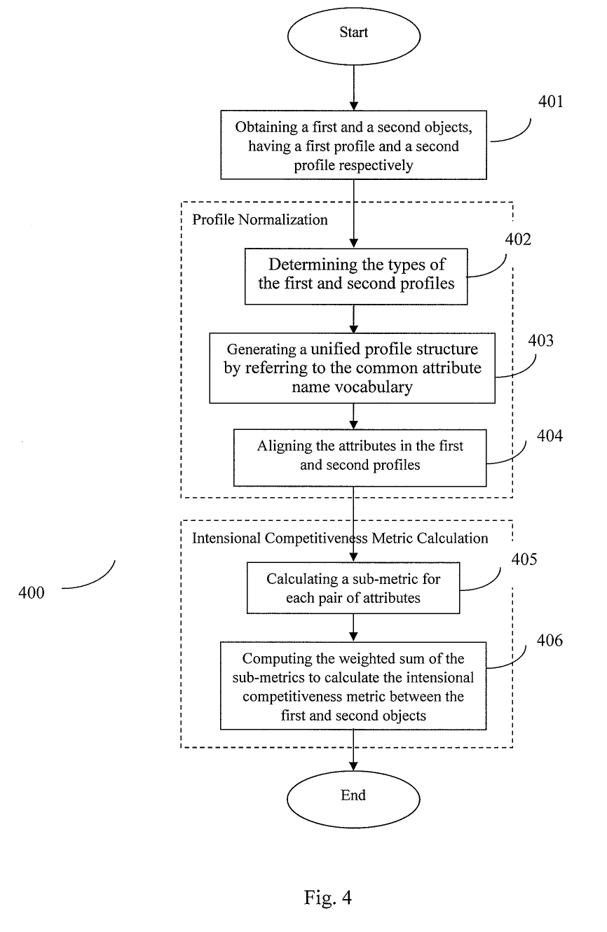

Below, the operation of the system 300 will be described first with reference to FIG. 4.

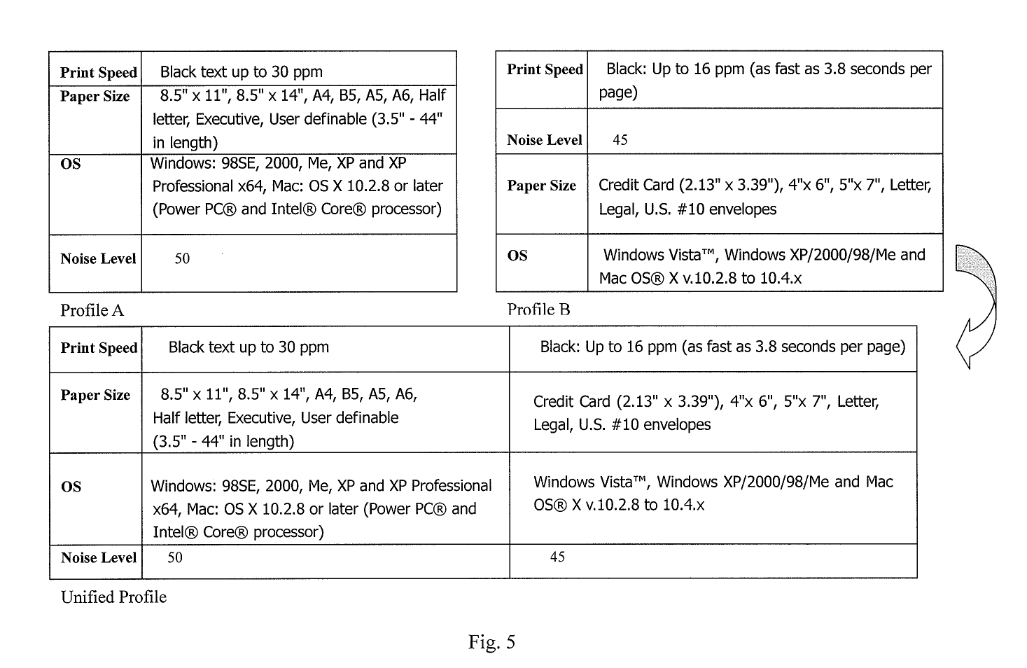

Like FIG. 2, the process begins with step 401 where the object obtain means 101 obtains a first and a second objects to be compared from the object database 105. The first and second objects have a first profile A=(A1-V_{A}1, A2-V_{A}2, . . . , Am-V_{A}m) and a second profile B=(B1-V_{B}1, B2-V_{B}2, . . . , Bn-V_{B}n) respectively. Next, in step 402, the determining unit 301 determines the types of the first and second profiles A and B. With this operation, the structures of the first and second profiles A and B are analyzed to determine if they are full-text or structural profiles, for the structural profile, what its schema is. Then in step 403, the unified profile structure generation unit 302 receives the result of the structure analysis from the determining unit 301, and with the support of the common attribute name vocabulary 1041, determines a unified profile structure (C1, C2, . . . Cs), namely, A=(C1-V_{A}1, C2-V_{A}2, . . . , Cs-V_{A}s) and B=(C1-V_{B}1, C2-V_{B}2, . . . , Cs-V_{B}s). Based on the determined unified profile structure and the common attribute name vocabulary 1041, the alignment unit 303 reorganizes the structures of the first and second profiles A and B to align the attributes in the first and second profiles A and B in their structures with the corresponding attributes in the unified profile (step 404). FIG. 5 shows an example of the attribute alignment process, wherein the profiles to be compared involve two kinds of printers, which includes the attributes of “Print Speed”, “Paper Size”, “OS” and “Noise Level”. As shown, the structures of the attributes in the first profile A and the second profile B are aligned according to the structure of the unified profile.

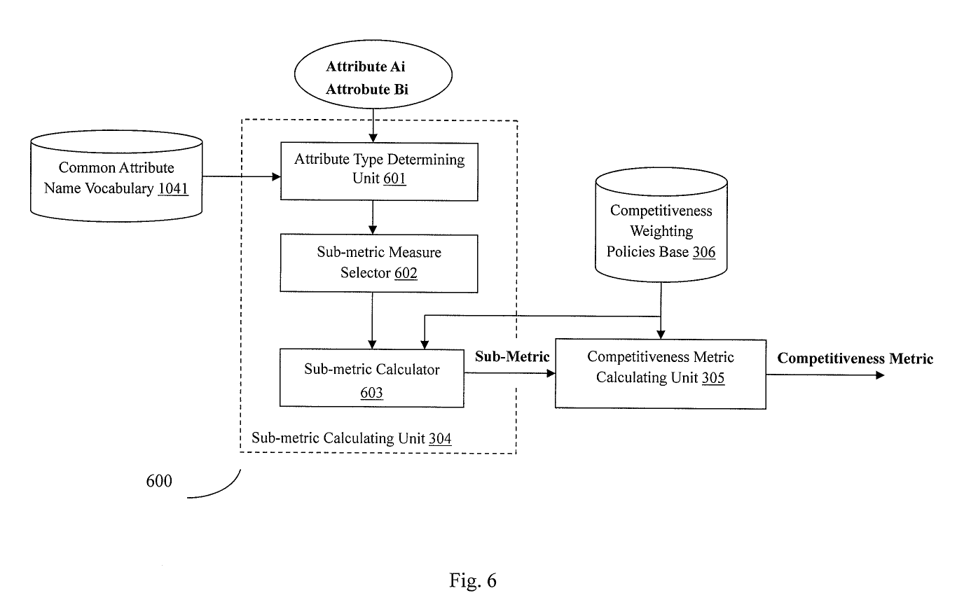

Then, in step 405, the aligned first profile A and second profile B are sent to the competitiveness sub-metric calculating unit 304 to compute the sub-metric of each of the attributes. The structure of the competitiveness sub-metric calculating unit 304 is shown in FIG. 6. The competitiveness sub-metric calculating unit 304 includes an attribute type determining unit 601, a sub-metric measure selector 602 and a sub-metric calculator 603. As shown, two attributes (values) Aᵢ=Cᵢ-V_{A}i and Bᵢ=Cᵢ-V_{B}i are first input to the attribute type determining unit 601. Here, the attributes Aᵢ and Bᵢ are belonged to the first profile A and the second profile B respectively and are aligned in their structures. As described above, each attribute-value is the specification about one aspect of the object (e.g. product), where the attribute name indicates which aspect of the object is described and the value includes the content to describe the attribute. The content of an attribute can be single-value or multi-value, and the attribute-value might be a simple data type or a complex data type. Typically, with respect to different data types, the computing methods for the competitiveness sub-metric are different. Generally, the single-value attributes are further divided into two cases: 1) for the attribute whose value is symbolic (e.g., enumeration data type or plain text); and 2) for the attribute whose value is numeric (e.g., float). For the symbolic attributes (e.g. full-text), a VSM-based method is often used for computing the competitiveness sub-metric, while for the numeric attributes, an attribute-value based method is used for computing the competitiveness sub-metric. The multi-value attributes are employed for handling the attribute with a set of values, which are also divided into two cases: 1) for the attribute whose multiple values are in sequence; 2) for the attribute whose multiple values are without sequence. In a real implementation, the competitiveness metric computing methods for the multi-value attributes might access the functionalities provided by the methods on the single-value attributes. About the determination of the content of the attribute and the data type, there are many methods capable of being introduced from the existing similarity measurement methods in the art, and thus their detailed description will be omitted here. Also, it should be noted that these cases are examples only and the present invention may be implemented in a different manner utilizing different data type definitions.

Next, according to the measurement method selected by the sub-metric measure selector 602, the sub-metric calculator 603 is used to compute the competitiveness sub-metric cᵢ (Aᵢ, Bᵢ) between the attributes Aᵢ and Bᵢ.

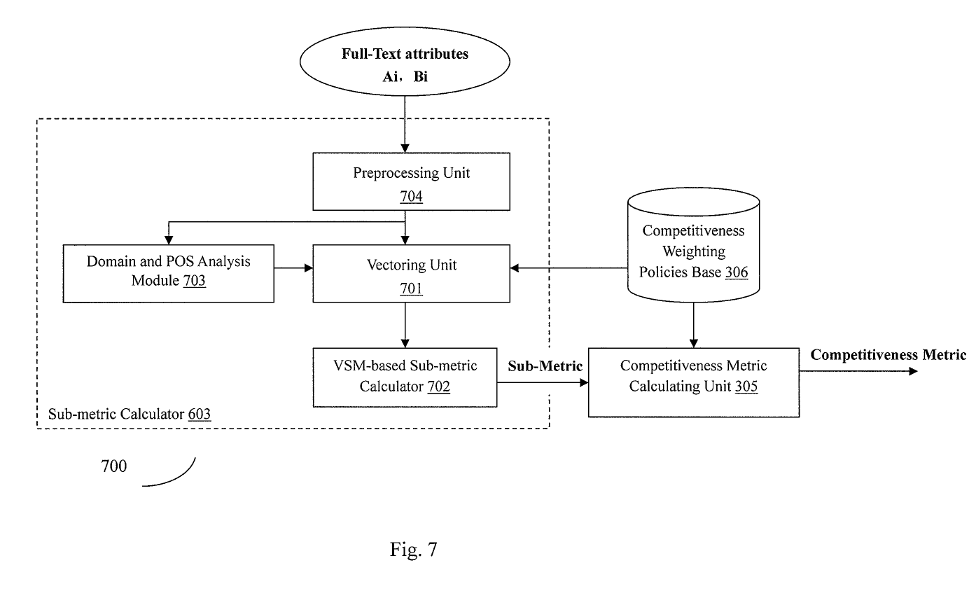

As described above, for the case that the value of an attribute comprises full-text content, the VSM-based similarity computing method can be adopted for computing the competitiveness sub-metric between the attributes. The detailed description will be given below with reference to FIG. 7. Basically, the VSM represents documents as a feature vector of the terms (words) that appear in the set of all the documents. In some embodiments, for example, when processing Chinese or Japanese documents, before generating the corresponding feature vector, it is necessary to first perform a domain and part of speech (POS) analysis on the terms (words) in the documents and apply weight strategies according to the analysis result. Similarity between documents is measured using one of several similarity measures (e.g., the Cosine and the Jaccard measures) that are based on such a feature vector.

FIG. 7 is a block diagram of the competitiveness sub-metric calculating unit when selecting the VSM-based method to compute the sub-metric of the attributes Aᵢ and Bᵢ in the case of the attribute type being determined as full-text. As shown in FIG. 7, in this example, the sub-metric calculator 603 includes a vectoring unit 701, a VSM-based sub-metric calculator 702 and a preprocessing unit 704. First, the full-text attributes Aᵢ and Bᵢ can be input into the preprocessing unit 704, where the name entities, such as the proper nouns, the product/company names, are deleted first since these name entities has no use for evaluating the competitiveness. As such, the accuracy of the competitiveness metric computation can be improved. Then, the preprocessed attributes Aᵢ and Bᵢ are input into the vectoring unit 701 for generating word-based vectors representing the full-text attributes Aᵢ and Bᵢ. Here, in order to further improve the accuracy of the competitiveness metric computation, a domain and POS analysis module 703 and a competitiveness weighting policies base 306 can be incorporated. Based on the analysis result of the domain and POS analysis module 703 for the relevant domain and POS of each word in the full-text attributes Aᵢ and Bᵢ, a rule table of the competitiveness weighting coefficients stored previously in the competitiveness weighting policies base 306 can be used to assign different competitiveness weighting coefficients (weights) to different words. In the full-text (structural) profile, a competitiveness coefficient is associated with each word (attribute), which is used to represent the importance of the word (attribute) in the competitiveness metric computation, through which the context-aware competitiveness weighting policies can be applied to improve the final accuracy. For example, when comparing two products from security software domain, the words “firewall, spam, invasion, virus” has higher coefficient (weight) value than the domain un-related words. With the analysis of the domain and POS analysis module 703, the preposition, conjunction, auxiliary words, interpunction, pronoun, exclamation, modal words, and onomatopoeic words make no contribution to the final metric, their competitiveness coefficient is set to be zero. In a real implementation, the rule table of the competitiveness weighting coefficients in the competitiveness weighting policies base 306 can be built manually or through some automatic way, e.g., keywords extraction based on the ontological product information from some 3^{rd} party websites (the words happened in the attribute-value of the structural profile with higher weights). However, the present invention is not limited to the specific examples, other methods for generating the rule table of the competitiveness weighting coefficients can also be used here.

Then, the word-based vectors representing the full-text attributes Aᵢ and Bᵢ generated by the vectoring unit 701 are input to the VSM-based sub-metric calculator 702 to generate the sub-metric cᵢ (Aᵢ, Bᵢ) between the attributes Aᵢ and Bᵢ using some existing VSM-based method.

Next, turning back to FIG. 4, in step 406, the sub-metrics of all the attributes in the aligned first and second profiles A and B are input to the competitiveness metric calculating unit 305 to calculate the final competitiveness metric between the first and second objects. As shown in FIG. 3, the calculated competitiveness metric will be stored in the competitiveness metric database 106. The competitiveness metric calculating unit 305 can obtain the final competitiveness metric in any of the known appropriate methods based on the sub-metrics of respective attributes. In the embodiment, the competitiveness metric calculating unit 305 obtains the final competitiveness metric by computing the weighed sum of the sub-metrics. In the embodiment, different weights have been assigned previously to respective attributes according to the common attribute name vocabulary 1041, and stored in the competitiveness weighting policies base 306. Therefore, the competitiveness metric of the first and second objects can be realized as:

$$Com ( A , B ) = {\sum }_{i = 1}^{s} {w}_{i} {c}_{i} ( {A}_{i} , {B}_{i} ) / {\sum }_{i = 1}^{s} {w}_{i} \qquad ( 1 )$$

wherein A and B are two profiles with a common structure that has s number of attributes, A=(A₁, . . . , Aₛ) and B=(B₁, . . . , Bₛ), cᵢ(Aᵢ, Bᵢ) is the competitiveness sub-metric of the ith attributes of the two profiles, wᵢ is the weight assigned to the ith attribute. As described above, the competitiveness weighting policies are from the competitiveness weighting policies base 306. Then, the process shown in FIG. 4 ends.

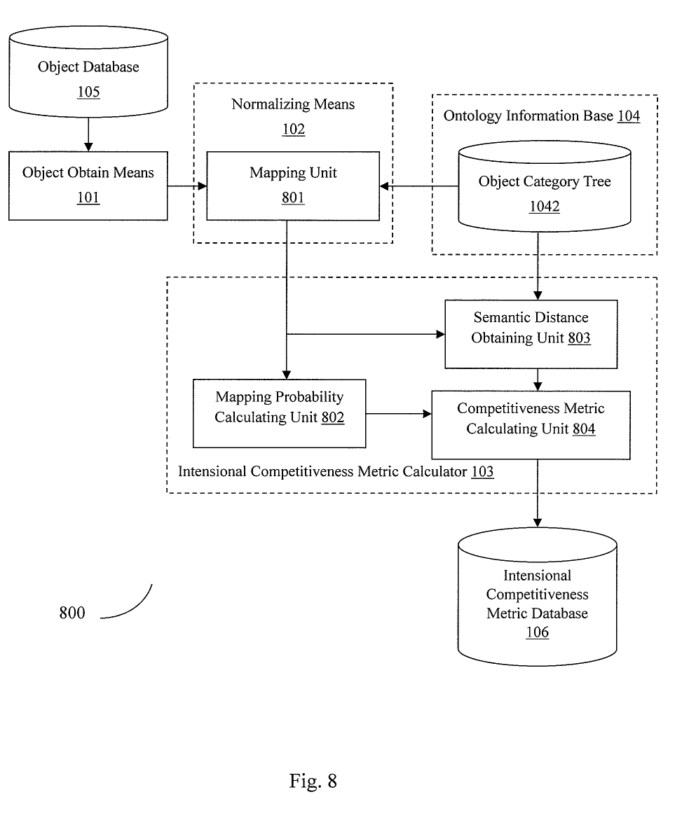

Below, the intensional competitiveness metric calculation in the indirect way will be described with reference to FIGS. 8-11. FIG. 8 is a detailed block diagram of the intensional competitiveness metric calculation system 800, which performs the normalization of the profiles by mapping them to the nodes in the object category tree (i.e. the indirect method). Differently from the direct way, as shown in FIG. 8, an object category tree 1042 is used as the ontology information for normalizing the profiles. The normalizing means 102 includes only a mapping unit 801, which receives the first object and the second object from the object obtain means 101, and maps the corresponding first and second profiles A and B to one or more nodes in the object category tree 1042. In this embodiment, the intensional competitiveness metric calculating means 103 includes a mapping probability calculating unit 802, a semantic distance obtaining unit 803 and a competitiveness metric calculating unit 804, which will be described in detail later, and is configured for computing the intensional competitiveness metric between the first and second objects.

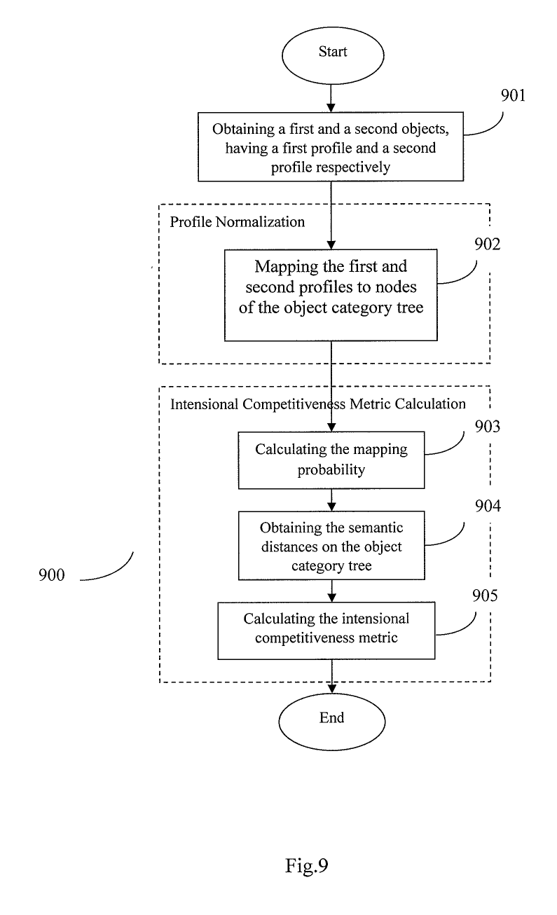

FIG. 9 shows a flow chart diagram for showing the operation of the system 800 shown in FIG. 8. Like the first embodiment shown in FIG. 4, the process 900 begins with the step 901, where a first and a second objects having a first profile A and a second profile B respectively are obtained from the object database 105. Next, in step 902, the first profile A and the second profile B are mapped to one or more nodes in the object category tree 1042.

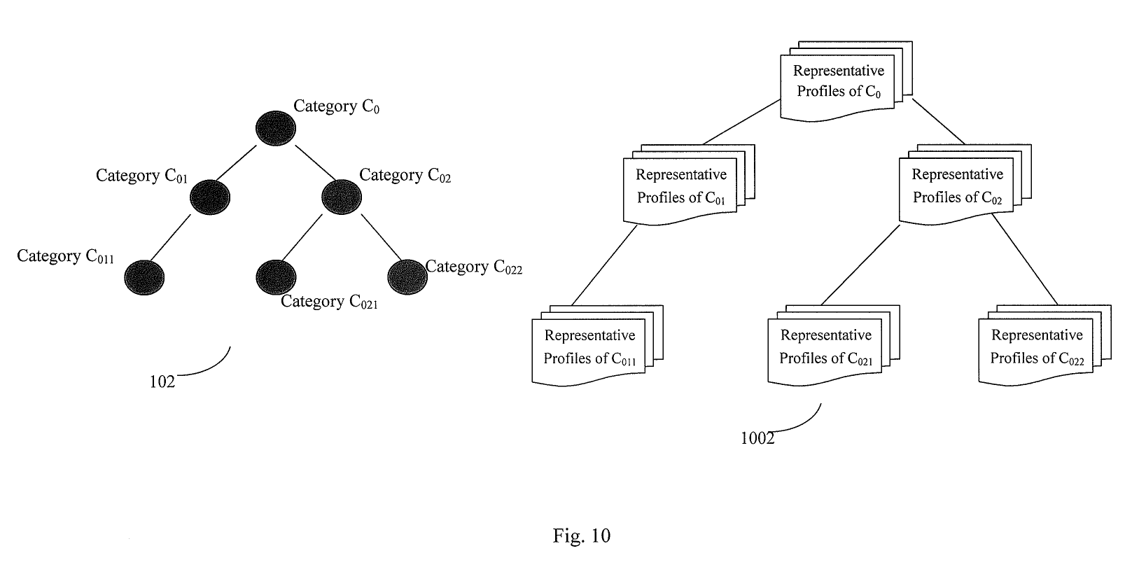

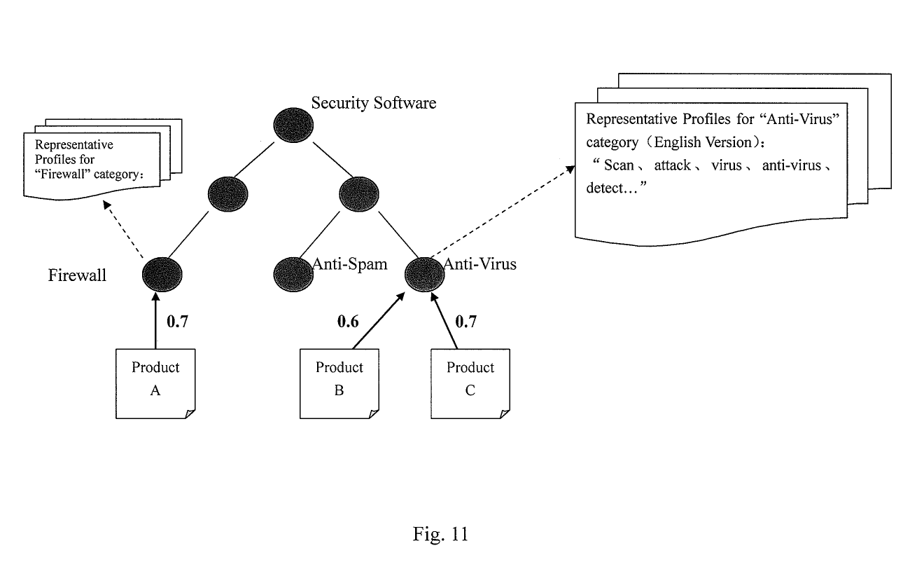

FIG. 10 is a schematic diagram for showing an object category tree 102 and the hierarchy 1002 of the representative profiles corresponding to the structure of the nodes in the object category tree 102. FIG. 11 shows an example of the computation of the competitiveness metric according to the second embodiment. As described above, the object category tree 102 is a common understanding of the interested domain about the categorization of the objects (e.g. products) in corresponding domain, where each node stands for one category. As shown in FIG. 10, the root category of the domain is C₀, which includes two subcategories, i.e. C₀₁ and C₀₂. The subcategory C₀₁ further includes a subcategory C₀₁₁, while the subcategory C₀₂ further includes two subcategories C₀₂₁ and C₀₂₂. In the practical application, the object category tree 102 can be obtained in advance in any of the well-known automatic or semi-automatic ways. For example, as shown in FIG. 11, in the security software domain, the root node of the object category tree 102 corresponds to a “Security Software” category, which further includes three leaves nodes, i.e. a “Firewall” category, a “Anti-Spam” category and a “Anti-Virus” category. Of course, the structure of the object category tree 102 is not limited to the shown example, and in different domains, the user can set different object category trees according to different requirements. Return to FIG. 10, it also shows a hierarchy 1002 of the representative profiles corresponding to the structure of the object category tree 102. Each node of the representative profiles hierarchy 1002 includes one or more representative profiles included in the object category at the corresponding node in the object category tree 102. The representative profile includes all the relevant keywords for describing the object category at the corresponding node. At each of the nodes, the representative profile is language-dependent, that is, there is a representative profile at each of the nodes corresponding to each specific language. The representative profiles hierarchy 1002 formed by representative profiles can be obtained in advance in any of the well-known automatic or semi-automatic ways.

Return to the step 902 of FIG. 9, in that step, the obtained first profile A and second profile B are mapped to one or more nodes in the object category tree 102, which can be achieved by existing VSM-based methods. In an embodiment, the mapping process is performed by taking the representative profiles in the representative profiles hierarchy 1002 as a medium. That is, the similarity between the profile (A or B) and the node/category at the corresponding position in the object category tree 102 can be computed by comparing the contents of each of the first and second profiles A and B with the representative profiles in the representative profiles hierarchy 1002 by using conventional VSM-based methods, so as to determine one or more (depending to the practical implementation) categories the corresponding object should belong to.

After determining the categories of the compared profiles A and B, the mapping result is sent to the competitiveness metric calculator 103 to compute the competitiveness metric between the first and second objects. As shown in FIG. 9, the process for computing the competitiveness metric mainly includes three steps, i.e. steps 903, 904 and 905. First, in step 903, the probabilities of mapping the first and second profiles A and B to different nodes are computed. As shown in FIG. 11, the product A is mapped to the “Firewall” category node in a probability of 0.7, the product B is mapped to the “Anti-Virus” category node in a probability of 0.6, and the product C is mapped to the “Anti-Virus” category node in a probability of 0.7. Then, the semantic distances between the nodes in the object category tree 102 are obtained in step 904. The semantic distance is used for characterizing the similarity between the object categories at the corresponding nodes, and can be computed previously with existing similarity metric computation methods and stored in the ontology information base 104. Assume that the distance between categories c1 and c2 is denoted as dc (c1, c2), then the similarity between the two categories is defined as corn (c1, c2)=1−dc (c1, c2). Here, the semantic distance between two categories is computed according to their respective positions on the object category tree 102. Generally, the basic idea is that the distances between upper level categories are bigger than those between lower level categories, and thus the similarity between upper level categories is smaller than that between lower level categories. Furthermore, the distance between ‘brothers’ should be longer than that between ‘father’ and ‘son’. Then, in step 905, the competitiveness metric between the first and second objects is computed by referring to the probabilities in which the first and second profiles A and B are mapped to the corresponding nodes and the obtained semantic distances between these nodes, which are obtained in steps 903 and 904. Here, the following two typical example cases are considered: (1) each of the first and second profiles A and B is mapped to only one node (category); or (2) the profiles A and B can be mapped to a plurality of nodes. In the case of describing that each of the profiles A and B is mapped to only one node, the probabilities of mapping the first and second profiles A and B to the corresponding nodes are 1. In this regard, the pre-calculated semantic distance between the two categories is utilized directly to measure the competitiveness between the first and second objects from the corresponding categories. That is, assume that the product A is only mapped to the category C₀₁₁ and the product B is only mapped to the category C₀₂₁, and the semantic distance between the categories C₀₁₁ and C₀₂₁ is 0.1, then the competitiveness metric between the product A and the product B is 0.1. Furthermore, in the case that the profiles A and B are mapped to a plurality of categories, the competitiveness metric can be computed by utilizing a cosine measure according to the probabilities in which the first and second profiles A and B are mapped to the corresponding nodes. In such a case, we can set two category vectors d_{A} and d_{B} for the profiles A and B respectively, and each element in one category vector denotes the probability of mapping the profile to a corresponding category. Then, a cosine measure (d_{A}×d_{B})/(|d_{A}∥d_{B}|) can be used to compute the competitiveness metric between the first and second objects having the first and second profiles A and B respectively. It should be noted that the semantic distances between different nodes are omitted here. However, it is easy to be conceived for those skilled in the art that the semantic distances between different nodes can also be integrated by using any of the suitable methods so as to improve the accuracy of the competitiveness metric computation.

For example, in the example shown in FIG. 11, the product A is mapped to the “Firewall” category node in a probability of 0.7, the product B is mapped to the “Anti-Virus” category node in a probability of 0.6, and the product C is mapped to the “Anti-Virus” category node in a probability of 0.7. Assume that the semantic distance between the “Firewall” node and the “Anti-Virus” node is computed previously as 0.1, then the intensional competitiveness metric between the products A and B (belonging to different categories) can be computed as 0.7×0.6×0.1=0.042, and the intensional competitiveness metric between the products B and C (belonging to the same categories) can be computed as 0.7×0.6=0.42. The intensional competitiveness metric computing method is not limited to the example. Then, the process shown in FIG. 9 ends.

Furthermore, as described above, the representative profiles at different nodes of the representative profiles hierarchy 1002 can be dependent on different languages. Therefore, the profiles A and B, which relate to different objects, can have different languages.

### [Extensional Competitiveness Metric Calculation]

Compared with the intensional competitiveness metric calculation, the extensional competitiveness metric calculation employs an extensional standard, namely, by analyzing the competitiveness relation instances provided explicitly by 3^{rd} parties information source (e.g. news or blogs websites) to obtain the extensional competitiveness metric. The competitiveness relation instances can be used for describing the competitiveness relation between different objects (e.g. products/companies). For example, a relation instance may record that “product A and product B compete in the exposition for the high-tech product award this year”, or “company A and company B cooperate to develop the new generation of products” etc. In some embodiments, the relation instances might be extracted from some News or Blogs websites by utilizing certain text mining or information extraction technologies well-known in the art. It is obvious that the extensional competitiveness metric between different objects can be derived by analyzing the competitiveness relation instances.

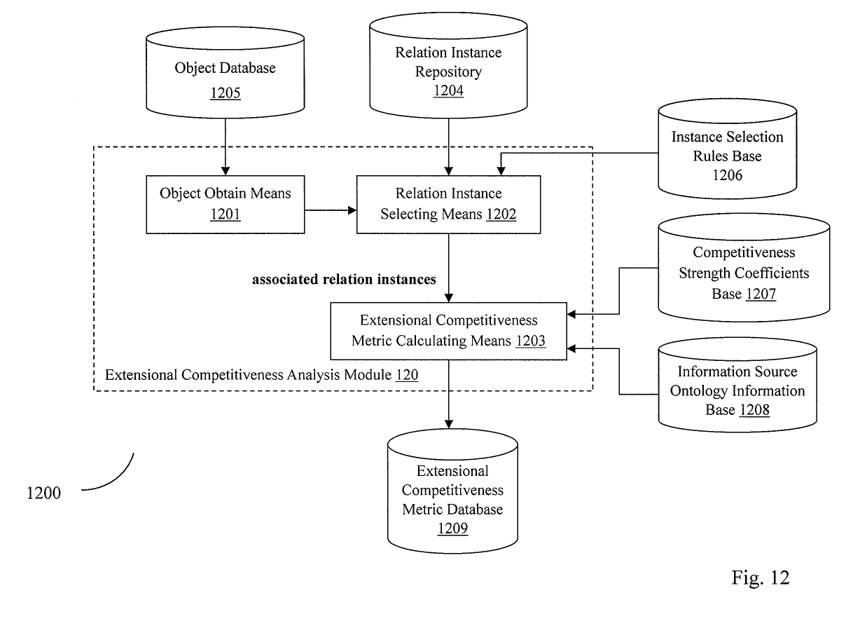

FIG. 12 is a structural block diagram of the extensional competitiveness metric calculation system 1200 for calculating the extensional competitiveness metric according to the present invention. As shown in FIG. 12, the major part of the system 1200 is an extensional competitiveness analysis module 120, which includes an object obtain means 1201, a relation instance selecting means 1202 and an extensional competitiveness metric calculating means 1203. Furthermore, the system 1200 further comprises a relation instance repository 1204, an object database 1205, an instance selection rules base 1206, a competitiveness strength coefficients base 1207, an information source ontology information base 1208, and an extensional competitiveness metric database 1209, wherein the object database 1205 stores the objects (e.g. product profiles) collected from the Web or other information sources, which are to be analyzed and processed by the extensional competitiveness analysis module 120. The relation instance repository 1204 stores the relation instances extracted from a plurality of information sources (e.g. news or blogs websites). The instance selection rules base 1206 stores a set of relation instances selection rules. The competitiveness strength coefficients base 1207 stores competitiveness-specific strength coefficients corresponding to the various instances in the relation instance repository 1204. Since people might utilize different language phenomena or description patterns in different News or Blogs websites for the relation specification (which will have great influence on the reader's feeling on the competitive strength between corresponding objects), typically, different strength coefficients are assigned to different types of relation instances. These strength coefficients can be stored in the competitiveness strength coefficients base 1207 in advance. The information source ontology information base 1208 can store credibility values of the information sources, which have provided the relation instances. The extensional competitiveness metric database 1209 is used for storing the calculated extensional competitiveness metric.

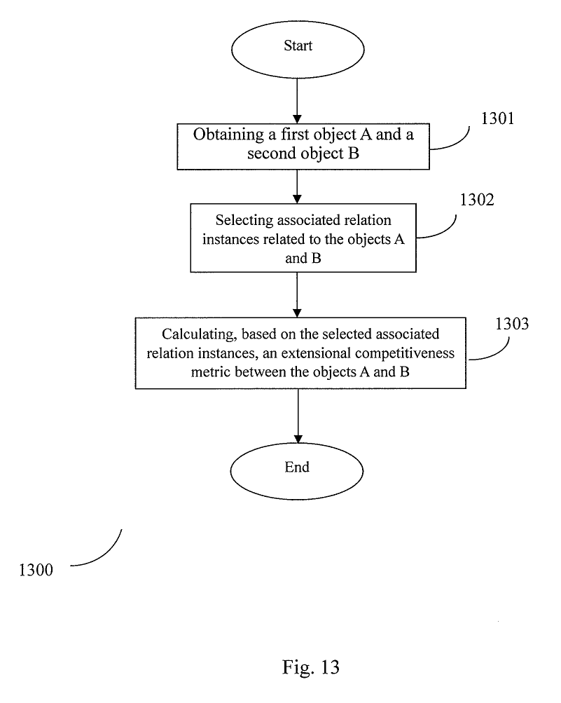

FIG. 13 is a flow chart diagram of an example of the operation process 1300 of the extensional competitiveness metric calculation system shown in FIG. 12. Like the intensional competitiveness metric calculation process, the process 1300 begins with step 1301 where a first object A and a second object B are obtained by the object obtain means 1201 from the object database 1205. Then, in step 1302, the relation instance selecting means 1202 selects, from the relation instances stored in the relation instance repository 1204, associated relation instances related to the first and second objects A and B according to the relation instance selection rules given by the instance selection rules base 1206. In one implementation, the selection (filtering) of the relation instances is preformed in an intuitive way, i.e., if the names of objects (e.g. products) A and B or their producers (e.g. the companies producing the products A and B) appear in a relation instance, it is regarded as an associated relation instance related to the objects A and B. Of course, it should be noted that the described relation instance selection rules are only used for the purpose of illustration, and the present invention is not limited to these rules. It is obvious to those skilled in the art that other relation instance selection rules can be conceived or provided according to different applications. Then, after the relation instance selecting means 1202 selecting the associated relation instances related to the first and second objects A and B, in step 1303, the extensional competitiveness metric calculating means 1203 calculates the extensional competitiveness metric between the objects A and B based on the selected associated relation instances. Then, the process 1300 ends.

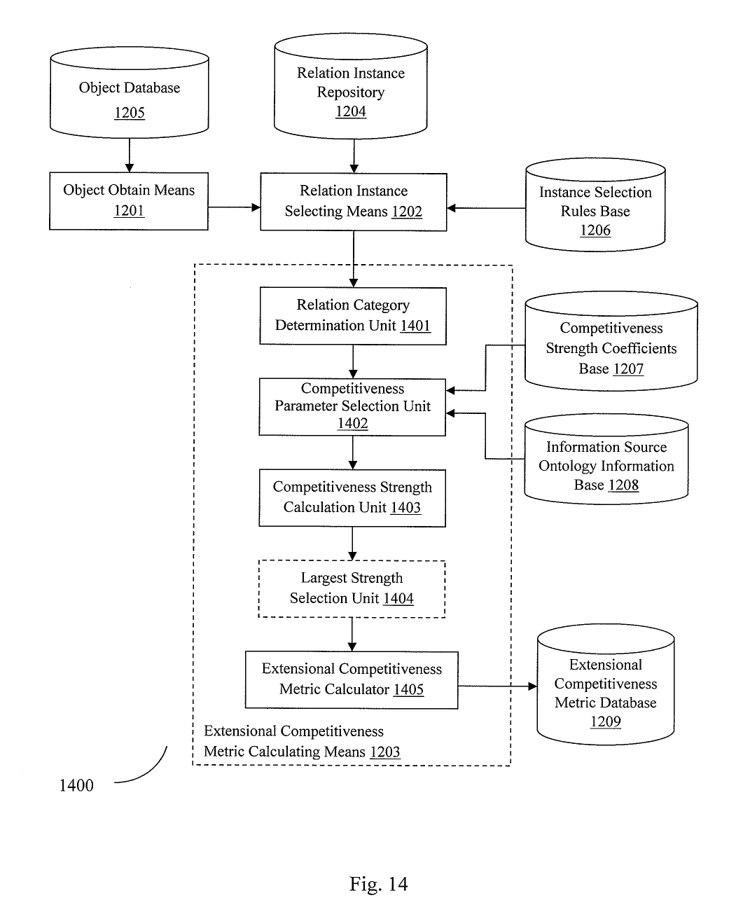

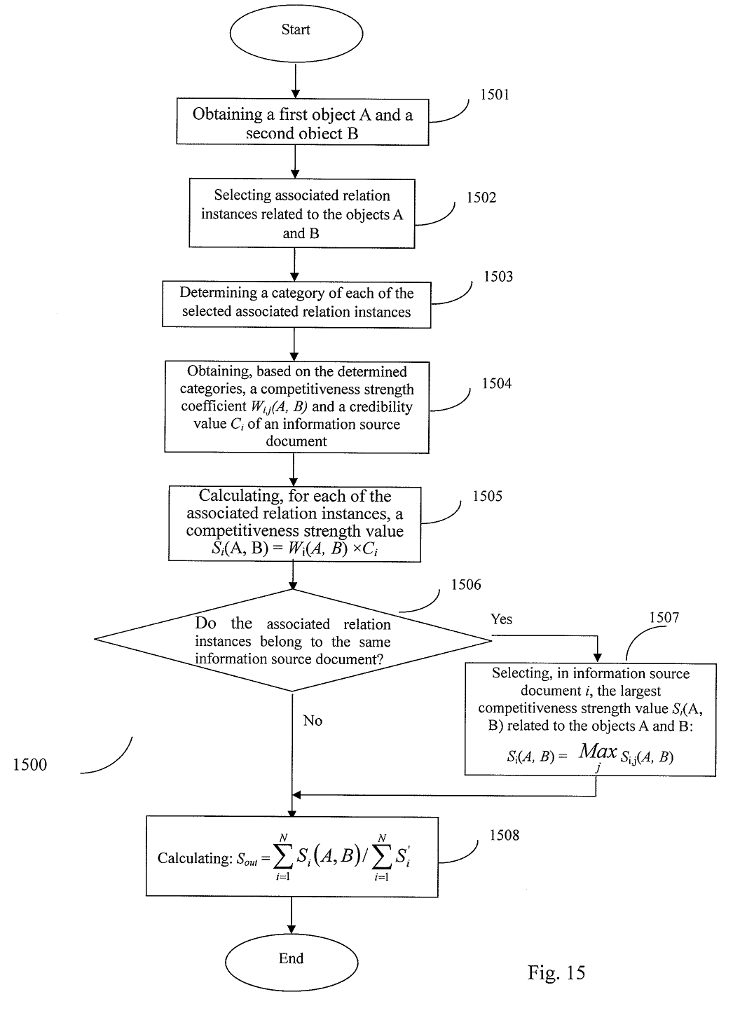

FIG. 14 is a detailed block diagram of an example of the extensional competitiveness metric calculation system of the present invention, which shows in more details the internal structure of the extensional competitiveness metric calculating means 1203. FIG. 15 is a flow chart diagram for showing the operation process 1500 of the extensional competitiveness metric calculation system shown in FIG. 14 for calculating the extensional competitiveness metric. It should be noted that the internal structure of the extensional competitiveness metric calculating means 1203 shown in FIG. 14 and the operation process 1500 shown in FIG. 15 are only provided as examples for illustrating the extensional competitiveness metric calculation, and should not be used to limit the present invention. It is easy for those skilled in the art to conceive other methods or structures for calculating the extensional competitiveness metric of objects according to the relation instances received from outside. According to practical applications, the internal elements constituting the extensional competitiveness metric calculating means 1203 can be added, reduced, combined or sub-combined appropriately, and the steps of the process shown in FIG. 15 can also be added or reduced and the order of the steps can be changed as appropriate.

With reference to FIG. 14, as shown, in addition to the same parts as that of the system shown in FIG. 12, the extensional competitiveness metric calculating means 1203 further comprises a relation category determination unit 1401, a competitiveness parameter selection unit 1402, a competitiveness strength calculation unit 1403, a largest strength selection unit 1404 and an extensional competitiveness metric calculator 1405. The largest strength selection unit 1404 is shown with the broken line block as an optional module, which is only to be used in the case that the associated relation instances related to the first and second objects A and B selected by the relation instance selecting means 1202 may belong to the same information source document (i.e. from the same document on a news or blog website). When a plurality of associated relation instances for the same pair of objects belong to the same information source document, only the relation instance having the largest competitiveness strength is used for the final extensional competitiveness metric calculation. The largest strength selection unit 1404 and its functions will be described later.

The competitiveness parameter selection unit 1402 is configured for acquiring corresponding competitiveness parameters from the competitiveness strength coefficients base 1207 and the information source ontology information base 1208 according to the contents of the selected associated relation instance related to the objects A and B. The competitiveness parameters include: (1) competitiveness strength coefficient Wᵢ(A, B) stored in the competitiveness strength coefficients base 1207, which correspond to different language phenomena or description patterns for the relation instances; and (2) credibility value Cᵢ of the information source stored in the competitiveness strength coefficients base 1207, wherein i is an index for identifying an document.

The operation process of the extensional competitiveness metric calculation system 1400 shown in FIG. 14 will be described in more details with reference to FIG. 15. As shown, similarly, the process begins with step 1501 where the object obtain means 1201 obtains a first object A and a second object B from the object database 1205. Then, in step 1502, the relation instance selecting means 1202 selects, from the relation instance repository 1204, associated relation instances relevant to the first and second objects A and B. As described above, in an implementation, the selection (filtering) of the relation instances is preformed in an intuitive way, i.e., if the names of objects (e.g. products) A and B or their producers (e.g. the companies producing the products A and B) appear in a relation instance, it is regarded as an associated relation instance related to the objects A and B. Of course, it should be noted that the described relation instance selection rules are only used for the purpose of illustration, and the present invention is not limited to these rules. It is obvious to those skilled in the art that other relation instance selection rules can be conceived or provided according to different applications. Then, in step 1503, the relation category determination unit 1401 in the extensional competitiveness metric calculating means 1203 determines a category of each of the selected associated relation instances, that is, determines the language description pattern of each of the associated relation instances and the index of the information source document that the relation instance belongs to so as to prepare for the acquirement of the appropriate competitiveness parameters later. In particular, each of the relation instances from the relation instance repository 1204 can be represented generally as a triplet, i.e., R=(RelationType, WeightID, NewsID). RelationType is used to denote the relation type of the relation instance, which can be selected from the group composed of competitive relation, cooperation relation and the like. When the relation instance selecting means 1202 selects associated relation instances related to the objects A and B, only the relation instances the type of which is competitive relation are selected. WeightID is used for identifying the language description pattern of the relation instance. Since different language description patterns can correspond to different competitiveness strength coefficients, this parameter WeightID can be used as an index for the competitiveness strength coefficient. NewsID is used to denote the information source document to which the relation instance belongs. Since different information source documents have different credibility values, this parameter NewsID can be used as index for the credibility value of the information source. Therefore, the competitiveness parameter selection unit 1402 can use the RelationType and NewsID as indexes respectively for searching the competitiveness strength coefficients base 1207 and the information source ontology information base 1208 for the competitiveness parameters corresponding to the objects A and B, namely, the competitiveness strength coefficient Wᵢ(A, B) and the credibility value Cᵢ of the information source corresponding to each of the associated relation instances.

Then, in step 1505, the competitiveness strength calculation unit 1403 calculates a competitiveness strength value for each of the associated relation instances. In an embodiment, the competitiveness strength can be calculated as: Sᵢ(A, B)=Wᵢ(A, B)×Cᵢ, wherein i is an index for identifying the information source document to which the associated relation instance belongs. Here, it should be noted that if there are a plurality of associated relation instances related to the objects A and B belong to the same information source document, only the associated relation instance having the largest competitiveness metric value is considered for calculation and other associated relation instances should be omitted. In particular, in step 1506, it is determined whether there are a plurality of associated relation instances related to the objects A and B belong to the same information source document. If so, in step 1507, the largest strength selection unit 1404 selects the largest competitiveness strength value with respect to the objects A and B in each information source document i. That is,

$${S}_{i} ( A , B ) = {Max}_{j} {S}_{i , j} ( A , B ) \qquad ( 2 )$$

wherein j denotes a number of each of the different associated relation instances related to the objects A and B in the belonged information source document i. If the respective associated relation instances related to the objects A and B belong to different information source documents, namely, each information source document includes only one associated relation instance related to the objects A and B, the largest strength selection unit 1404 is omitted, and the competitiveness strength value Sᵢ(A, B) corresponding to each of the associated relation instances is used directly for the final extensional competitiveness metric calculation.

In step 1508, according to an embodiment, the extensional competitiveness metric between the objects A and B is calculated as:

$${S}_{out} = {\sum }_{i = 1}^{N} {S}_{i} ( A , B ) / {\sum }_{i = 1}^{N} {S}_{i}^{′} \qquad ( 3 )$$

wherein N denotes the total number of the information source documents to which all of the relation instances stored in the relation instance repository belong, Sᵢ(A, B) denotes the largest competitiveness strength value in the information source document i for the associated relation instances related to the objects A and B, Sᵢ′ denotes the largest competitiveness strength value in the information source document i for all associated relation instances (including the relation instances related or non-related to the objects A and B). In particular, Sᵢ′ can be represented as:

$${S}_{i}^{′} = {Max}_{A , B} {S}_{i} ( A , B ) \qquad ( 4 )$$

However, it is obvious to those skilled in the art that the calculation of the extensional competitiveness metric is not limited to the above-described equation (3). Other calculation methods can also be conceived. For example, in order to get a more meaningful value for human judgers, alternatively, the following log form of the equation (3) can be adopted:

$${S}_{out} = log {\sum }_{i = 1}^{N} {S}_{i} ( A , B ) / log {\sum }_{i = 1}^{N} {S}_{i}^{′} \qquad ( 5 )$$

Furthermore, according to the above equation (3), it is obvious that if the influence of different language phenomena or description patterns to the calculation result is not taken into account during the extensional competitiveness metric calculation and assume that all of the associated relation instances have the same competitiveness strength value 1, the numerator of the equation (3) could be simplified as the number of the information source documents to which the associated relation instances related to the objects A and B belong, and the denominator of the equation (3) could be simplified as the total number of the information source documents to which all of the relation instances stored in the relation instance repository belong. Thereby, the extensional competitiveness metric Sₒᵤₜ between the objects A and B can be calculated as the ratio of the number of the information source documents to which the associated relation instances related to the objects A and B belong and the total number of all of the information source documents, namely, the frequency that the associated relation instances appear in all the information source documents. Therefore, in some embodiments, the frequency that the associated relation instances related to the objects A and B appear in all the information source documents can be used for characterizing the extensional competitiveness metric between the objects A and B. However, the foregoing is only used as an example for the extensional competitiveness metric calculation and should not be used to limit the scope of the present invention.

Then, after the calculation of the extensional competitiveness metric Sₒᵤₜ between the objects A and B in step 1508, the process 1500 shown in FIG. 15 ends.

Considering the fact that there might be time, location/area, industry domain, or other relevant additional information together with the news/blogs or the extracted relation instances, the complete representation of a relation between the objects might be expressed as: R(A, B)=(RelationType, WeightID, Domain, Area, Time, NewsID). Domain, Area and Time denote the industry domain, area and time relevant to the relation instance. For example, Domain may indicate that company A and company B compete in the “mobile phone” domain, Area may indicate that product A and product B compete in China, and Time may indicate that product A and product B competed in the year of 2002-2003. In such a way, further specific competitiveness analysis can be conducted to support diverse requirements from business decision making.

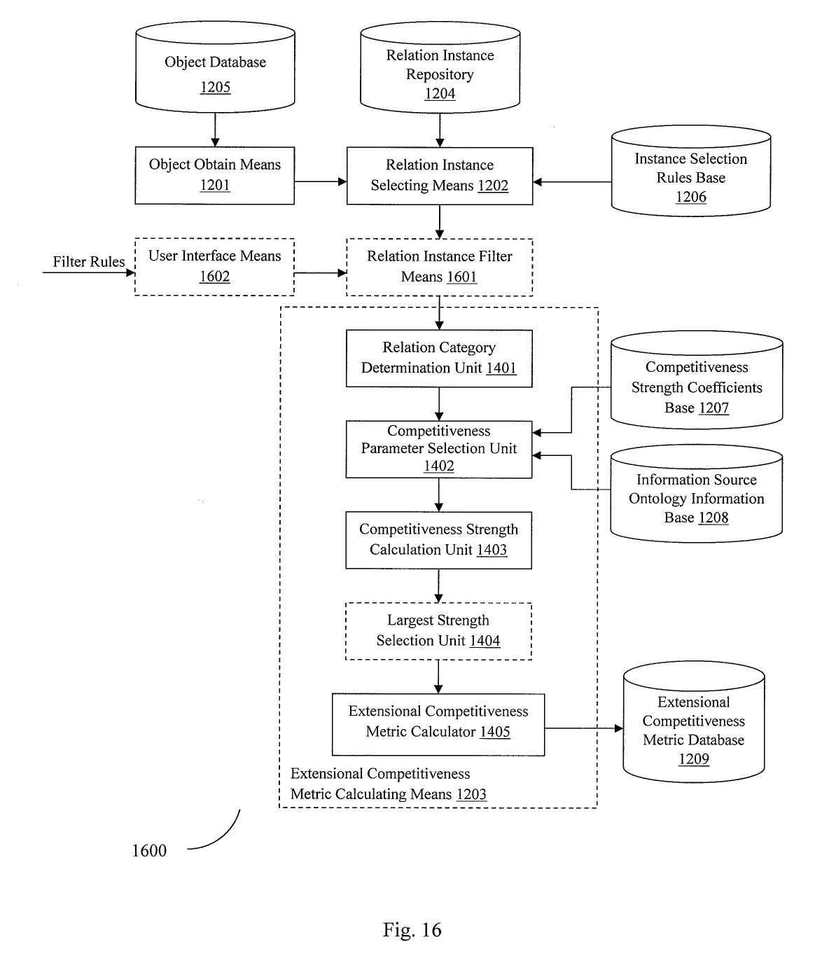

FIG. 16 is a detailed block diagram of another example of the extensional competitiveness metric calculation system 1600 of the present invention. Compared with the system 1400 shown in FIG. 14, the system 1600 incorporates a relation instance filter means 1601 and a user interface means 1602 for performing temporal, area or domain analysis on the extensional competitiveness strength between objects according to the additional information in the associated relation instances. Through the user interface means 1602, the user can input some filter rules about time, area or domain. The relation instance filter means 1601 can further filter the associated relation instances selected by the relation instance selecting means 1202 according to the input filter rules to obtain the relation instances satisfying specific requirements. For example, the relation instances of the objects between which there is competitiveness in a specific area (e.g. in China) can be filtered out, or the relation instances of the objects between which there is competitiveness during a specific period of time (e.g. in 2005) can be filtered out, etc. In such a way, the extensional competitiveness analysis between different objects can be carried out in a more detailed way and answer for the requirements of different users.

For the time-related information that related to the relation instance, the final competitiveness metric from extensional competitiveness metric calculation will be generated together with corresponding time stamp, through which the temporal (time-dependent) analysis of the competitive relation can be supported. For example, objects A and B competed with each other during certain period and become partners after that period.

Furthermore, if the industry domain ontology has been constructed, the industry domain information can be considered as an important factor in the competitiveness relation computing. Basically, since multiple domains might form a hierarchy, the extracted relation instances can be propagated through the domain hierarchy (between domain and sub-domain) along two ways, i.e., downward and upward. For the downward propagation, a preferred embodiment is Sᵢ(A, B, dj)=Sᵢ(A, B, D), where the domain dj is a child-domain of domain D. Similarly, for the upward propagation, a preferred implementation is Sᵢ(A, B, D)=MaxSᵢ(A, B, dj). Therefore, the competitiveness metric between the objects in different domains can be calculated through the hierarchy between a plurality of domains indicated by the industry domain ontology.

Similarly, for the location or area related information together with the relation instances, corresponding reasoning can be conducted to produce further more detailed information regarding the market area of the competitiveness relation between relevant objects (e.g., companies or products).

### [Integrated Competitiveness Metric Calculation]

In the integrated competitiveness metric calculation according to the embodiment of the present invention, it is provided a dynamic mechanism to integrate or combine the above-mentioned intensional and extensional competitiveness metric calculations together. Since the final generated integrated competitiveness metric reflects not only the similarity between the object profiles, but also the comments from the 3^{rd} parties, the integrated competitiveness metric calculation result is more comprehensive than the pure intensional analysis (content-based competitiveness analysis) or extensional analysis.

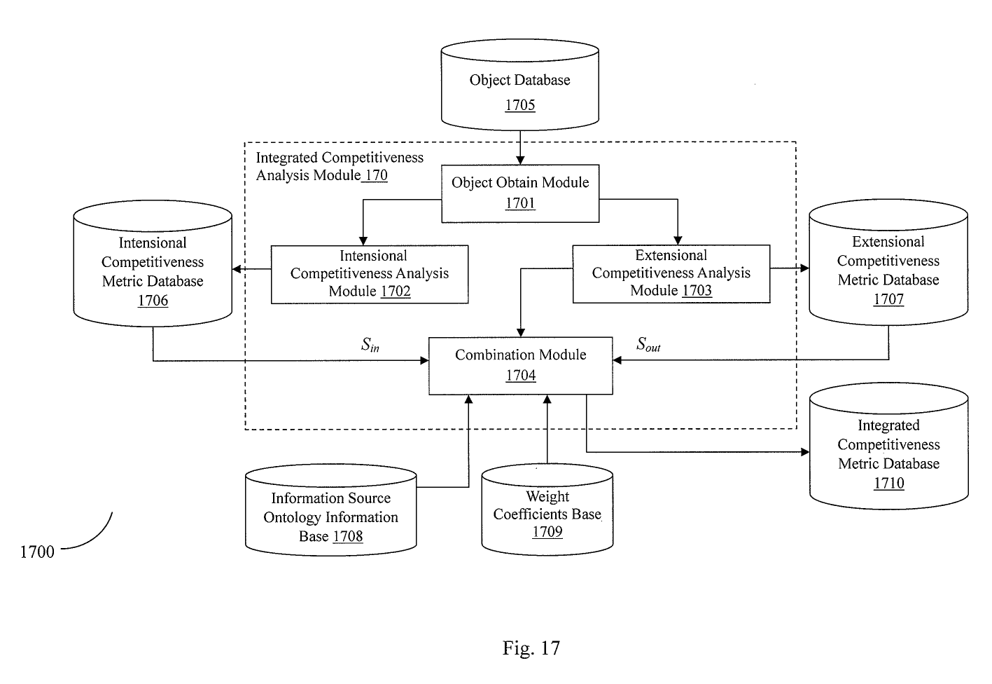

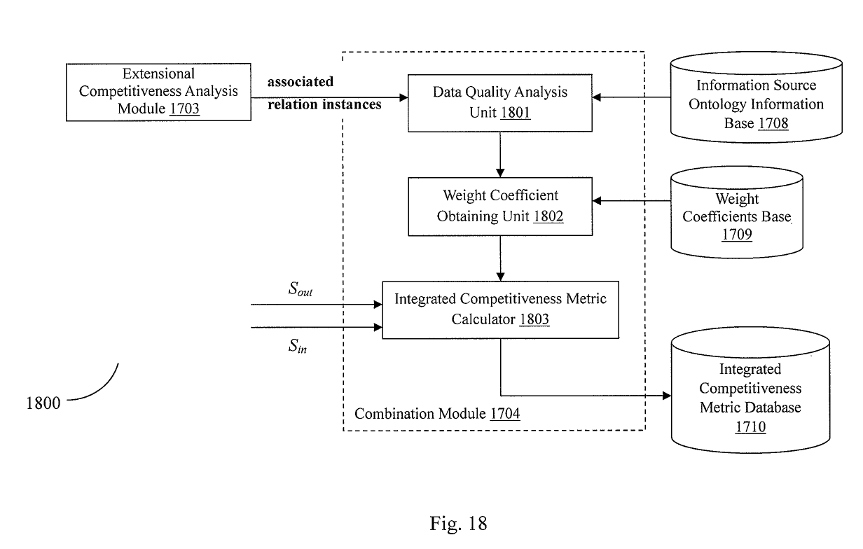

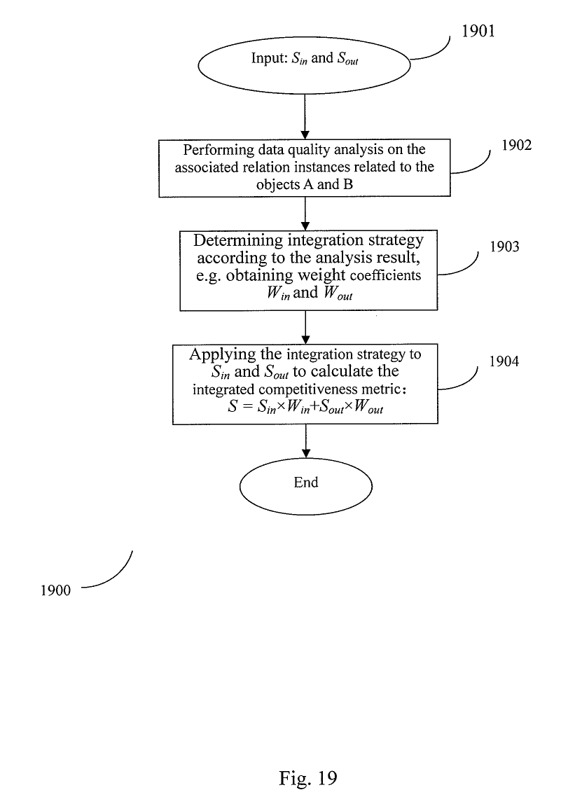

FIG. 17 is a structural block diagram of the integrated competitiveness metric calculation system 1700 for calculating the integrated competitiveness metric according to the present invention. FIG. 18 is a detailed block diagram of an example of the combination module 1704 in the integrated competitiveness metric calculation system shown in FIG. 17. FIG. 19 is a flow chart diagram for showing the process of combining the intensional and extensional competitiveness metrics.

With reference to FIG. 17 first, the major part of the integrated competitiveness metric calculation system 1700 is an integrated competitiveness analysis module 170 and a plurality of databases provided with the integrated competitiveness analysis module 170, namely, a object database 1705, an intensional competitiveness metric database 1706, an extensional competitiveness metric database 1707, an information source ontology information base 1708, a weight coefficients base 1709 and an integrated competitiveness metric database 1710. The integrated competitiveness analysis module 170 includes an object obtain module 1701, an intensional competitiveness analysis module 1702, an extensional competitiveness analysis module 1703 and a combination module 1704. The intensional competitiveness analysis module 1702 can employ the internal structure of the intensional competitiveness metric calculating system 100 shown in FIG. 1, but the present invention is not limited to this. It will be understood for those skilled in the art that other well-known intensional competitiveness metric calculating technologies can also be used to implement the intensional competitiveness analysis module 1702 of the present invention. The extensional competitiveness analysis module 1703 can employ the internal structure of the extensional competitiveness metric calculating system 1200 shown in FIG. 12, but the present invention is not limited to this. It will be understood for those skilled in the art that other well-known extensional competitiveness metric calculating technologies can also be used to implement the extensional competitiveness analysis module 1703 of the present invention.

As shown in FIG. 17, the object obtain module 1701 first obtains a first object A and a second object B from the object database 1705. The objects A and B are input to the intensional competitiveness analysis module 1702 and the extensional competitiveness analysis module 1703 respectively to calculate an intensional competitiveness metric Sᵢₙ and an extensional competitiveness metric Sₒᵤₜ between the objects A and B. The calculated intensional competitiveness metric Sᵢₙ and extensional competitiveness metric Sₒᵤₜ are stored in the intensional competitiveness metric database 1706 and the extensional competitiveness metric database 1707 respectively. Then, the combination module 1704 obtains the intensional competitiveness metric Sᵢₙ and extensional competitiveness metric Sₒᵤₜ between the objects A and B from the intensional competitiveness metric database 1706 and the extensional competitiveness metric database 1707, and combine the intensional and extensional competitiveness metrics with a kind of dynamic mechanism to generate the final integrated competitiveness metric. The generated integrated competitiveness metric between the objects A and B is stored in the integrated competitiveness metric database 1710.

The structure of the combination module 1704 and its operation process will be described below with reference to FIGS. 18 and 19.

As shown in FIG. 18, in the example, the combination module 1704 includes a data quality analysis unit 1801, a weight coefficient obtaining unit 1802 and an integrated competitiveness metric calculator 1803. With reference to FIG. 19, the intensional competitiveness metric Sᵢₙ and extensional competitiveness metric Sₒᵤₜ calculated by the intensional competitiveness analysis module 1702 and the extensional competitiveness analysis module 1703 are inputted to the combination module 1704 (step 1901). Then, in step 1902, the data quality analysis unit 1801 performs data quality analysis on the associated relation instances related to the first and second objects A and B from the extensional competitiveness analysis module 1703. In particular, the data quality analysis unit 1801 analyzes the data quality of the associated relation instances provided from the extensional competitiveness analysis module 1703 with reference to the credibility values of respective information sources in the information source ontology information base 1708.

The data quality evaluation will play an important role in the process of combining the sub-metrics (i.e. the intensional and extensional metrics) where there might be inconsistencies between the extensional and intensional semantic analysis results. For example, two companies have strong competitive relation from the extensional competitiveness analysis, however these two companies have almost no similar features, i.e., they don't compete with each other from the intensional analysis result. To deal with such cases, a dynamic mechanism is adopted for balancing the inconsistencies between the extensional and intensional semantic analysis results, which mainly depends on: (1) the data quality evaluation result (i.e., the credibility of corresponding information sources); and (2) the additional information statistical analysis. The additional information can include time information, domain information and market (area) information, wherein through dividing different domains, market areas and periods, more accurate competitiveness analysis result can be derived. For example, two companies A and B might compete in certain period on a special market, but at present, one of them has exited from that market and there is no competitiveness any more.

Return to FIG. 19, after determining in step 1902 the data quality analysis result on the associated relation instances, in step 1903, the integration strategy will be determined. For example, in an example, the weight coefficient obtaining unit obtains from the weight coefficients base 1709 the weight coefficients Wᵢₙ and Wₒᵤₜ to be used for the intensional and extensional competitiveness metrics respectively. Then, in step 1904, the integrated competitiveness metric calculator 1803 applies the determined integration strategy (i.e. the obtained weight coefficients) to the intensional and extensional competitiveness metrics Sᵢₙ and Sₒᵤₜ to calculate the integrated competitiveness metric S. In this example, the integrated competitiveness metrics S can be calculated as:

S=Sᵢₙ×Wᵢₙ+Sₒᵤₜ×Wₒᵤₜ (6)

The forgoing method makes the combination of the sub-metrics can be adjusted dynamically. However, the method of adjusting the competitiveness sub-metrics by the adaptive weight coefficients is only used as an example. It is easy to understand for those skilled in the art that according to the practical applications, other integration strategies can also be used for balancing the inconsistencies between the extensional and intensional semantic analysis results.

Finally, the integrated competitiveness metric S calculated by the integrated competitiveness metric calculator 1803 is stored in the object obtain module 1701 (see FIG. 18).

Furthermore, it should be noted that similar to the above extensional competitiveness metric calculation, since the competitiveness metrics as the intensional and extensional competitiveness analysis results may include corresponding additional information, such as time information, industry domain information and location/area information, the integrated competitiveness metric calculation can also perform multiple dimensions (i.e. time, domain and area) analysis of the competitiveness between the objects.

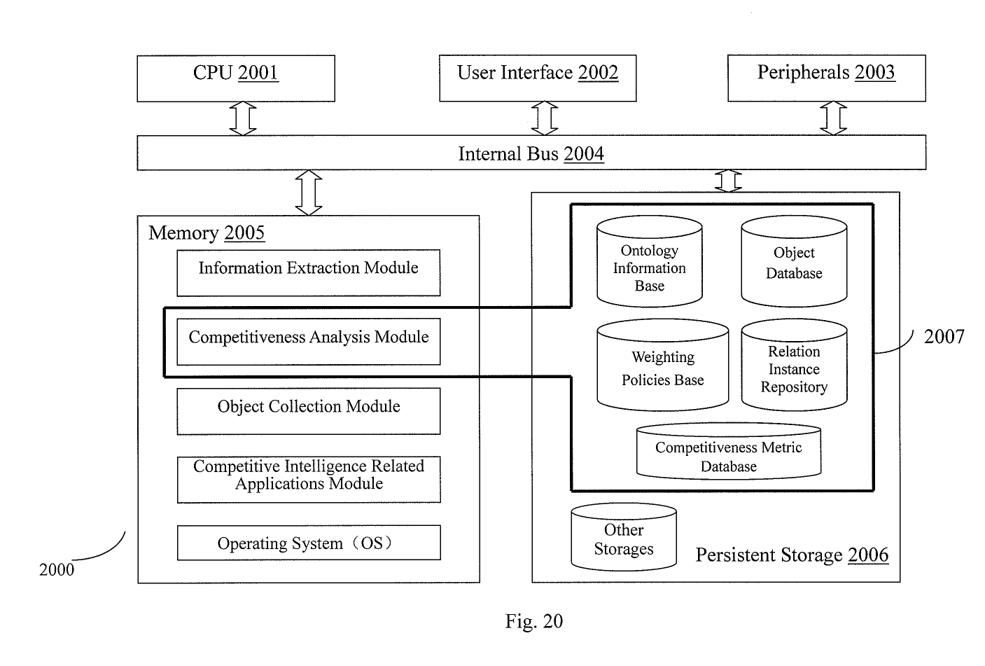

The forgoing is used for describing the intensional, extensional and integrated competitiveness metric calculations according to the present invention. FIG. 20 is a schematic block diagram of the computer system 2000 that is used to implement the present invention. As shown, the computer system 2000 includes a CPU 2001, a user interface 2002, the peripherals 2003, a memory 2005, a persistent storage 2006 and an internal bus 2004, which connects the foregoing components with each other. The memory 2005 further includes an information extraction module, a competitiveness analysis module, an object collection module, a competitive intelligence related applications module and an operating system (OS) etc. The persistent storage 2006 stores the various databases related to the present invention, such as a ontology information base, an object database, a weighting policies base, a relation instance repository, a competitiveness metric database etc. The parts related to the present invention is shown in the figure as surrounded by the bold line, wherein the competitiveness analysis module may be the intensional competitiveness analysis module shown in FIG. 1, the extensional competitiveness analysis module shown in FIG. 12 or the integrated competitiveness analysis module shown in FIG. 17. Furthermore, the persistent storage 2006 can also include other storages.

The intensional, extensional and integrated (combined) competitiveness metric calculations between different objects (e.g. products/companies) according to the present invention have been described above with reference to the accompanying drawings. From the above description, the effects of the present invention are as follows.

In the intensional competitiveness metric calculation under the direct way, the profiles representing different objects are compared directly by aligning the corresponding attributes, and thus a flexible mechanism is provided to combine the word-based (VSM-based) and attribute-based methods in the domain of similarity computing. It enables the competitiveness metric calculation algorithm according to the present invention having the capability to handle the subjects with heterogeneous structural (attribute-value) and/or unstructured (plain text) profiles. Furthermore, the direct profile comparison method can take advantage of the profile data quality as much as possible to improve the accuracy of the final competitiveness metric.

Furthermore, through indirect intensional competitiveness metric calculation, the language barrier is overcome for globalized competitor finding. Also, since the common taxonomic hierarchy (i.e. the object category tree) is used as a medium for competitiveness scoring, the efficiency can have a significantly improvement comparing with one-to-one profile comparison. In the method of indirect competitiveness metric calculation, there is no direct query/document translation (adopted popularly in the domain of cross-language information retrieval), and thus the corresponding shortcomings (e.g., unknown-term translation and complexity for translation based method, and unavailability of sufficient parallel corpora for corpus-based method) in the prior arts can be obviated.

With the extensional competitiveness metric calculation method and system, since the extensional competitiveness metric is generated from the relation instances expressed explicitly from 3rd parties (e.g., news or blogs, which are said by others), the resulting competitiveness metric is more objective than the result of intensional competitiveness metric calculation.

Furthermore, in the integrated competitiveness metric calculation, a dynamic mechanism to combine intensional competitiveness metric calculation and the extensional competitiveness metric calculation is provided, through which the quality of the information source can be exploited as much as possible (knowledge provenance analysis). Since the final integrated competitiveness metric reflects not only the similarity of object profiles but also the comments from 3rd parties, the integrated competitiveness analysis can get a more comprehensive result comparing to the absolute intensional competitiveness analysis (content-based competitiveness analysis) or extensional competitiveness analysis methods.

Furthermore, in the extensional or integrated competitiveness metric calculation, besides the competitiveness metric, the time-stamp together with the news/blogs from the Web could be mapped to the relation instance and then to the final competitiveness metric, through which the temporal (time-dependent) analysis of the competitive relation can be supported. Other additional information together with the relation instance might include the locations or industry domains, which can also provide corresponding potential support for certain specific market analysis.

It should be noted that the competitiveness metric computing method of the present invention could also be applied to the similarity computation in order to improve the accuracy of the current similarity metric computing technologies.

The specific embodiments of the present invention have been described above with reference to the accompanying drawings. However, the present invention is not limited to the particular configuration and processing shown in the accompanying drawings. For example, in the process of computing the competitiveness sub-metric between different attributes, in addition to the VSM-based method and the attribute-value based method, any of the other similarity measurement technologies known in the art can also be used. Also, for the purpose of simplification, the description to these existing methods and technologies is omitted here.

In the above embodiments, several specific steps are shown and described as examples. However, the method process of the present invention is not limited to these specific steps. Those skilled in the art will appreciate that these steps can be changed, modified and complemented or the order of some steps can be changed without departing from the spirit and substantive features of the invention.

The elements of the invention may be implemented in hardware, software, firmware or a combination thereof and utilized in systems, subsystems, components or sub-components thereof. When implemented in software, the elements of the invention are programs or the code segments used to perform the necessary tasks. The program or code segments can be stored in a machine-readable medium or transmitted by a data signal embodied in a carrier wave over a transmission medium or communication link. The “machine-readable medium” may include any medium that can store or transfer information. Examples of a machine-readable medium include electronic circuit, semiconductor memory device, ROM, flash memory, erasable ROM (EROM), floppy diskette, CD-ROM, optical disk, hard disk, fiber optic medium, radio frequency (RF) link, etc. The code segments may be downloaded via computer networks such as the Internet, Intranet, etc.

Although the invention has been described above with reference to particular embodiments, the invention is not limited to the above particular embodiments and the specific configurations shown in the drawings. For example, some components shown may be combined with each other as one component, or one component may be divided into several subcomponents, or any other known component may be added. The operation processes are also not limited to those shown in the examples. Those skilled in the art will appreciate that the invention may be implemented in other particular forms without departing from the spirit and substantive features of the invention. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for calculating competitiveness metric between objects, comprising:
obtaining a first object and a second object;
selecting, from all the relation instances stored in a relation instance repository, associated relation instances related to the first and second objects; and
calculating, based on the selected associated relation instances, an extensional competitiveness metric Sₒᵤₜ between the first and second objects as the competitiveness metric between the first and second objects.

2. The method according to claim 1, wherein calculating the extensional competitiveness metric Sₒᵤₜ between the first and second objects comprises calculating a ratio of the number of information source documents that the associated relation instances related to the first and second objects belong to and the total number of information source documents that all relation instances stored in the relation instance repository belong to, as the extensional competitiveness metric Sₒᵤₜ between the first and second objects.

3. The method according to claim 1, wherein each of the selected associated relation instances related to the first and second objects belongs to different information source document, and calculating the extensional competitiveness metric Sₒᵤₜ between the first and second objects comprises:
determining a relation category of each of the selected associated relation instances related to the first and second objects;
obtaining, based on the determined relation categories, a competitiveness strength coefficient Wᵢ(A, B) corresponding to each of the associated relation instances and a credibility value Cᵢ of an information source document that the associated relation instance belongs to, wherein i denotes the information source document the associated relation instance belongs to;
calculating, for each of the associated relation instances, a competitiveness strength value Sᵢ(A, B)=Wᵢ(A, B)×Cᵢ; and
calculating, based on all information source documents that all relation instances stored in the relation instance repository belong to, the extensional competitiveness metric Sₒᵤₜ between the first and second objects as follow:
$${S}_{out} = {\sum }_{i = 1}^{N} {S}_{i} ( A , B ) / {\sum }_{i = 1}^{N} {S}_{i}^{′}$$
wherein N denotes the total number of the information source documents that all relation instances stored in the relation instance repository belong to, Sᵢ′ denotes the largest competitiveness strength value for all relation instances in the information source document i, A and B denotes the first and second objects respectively.

4. The method according to claim 1, wherein the respective associated relation instances related to the first and second objects can belong to the same information source document, and calculating the extensional competitiveness metric Sₒᵤₜ between the first and second objects comprises:
determining a relation category of each of the selected associated relation instances related to the first and second objects;
obtaining, based on the determined relation categories, a competitiveness strength coefficient W_{i,j}(A, B) corresponding to each of the associated relation instances and a credibility value Cᵢ of an information source document that the associated relation instance belongs to, wherein i denotes the information source document the associated relation instance belongs to, and j denotes a reference number of the associated relation instance in the information source document i;
calculating, for each of the associated relation instances, a competitiveness strength value S_{i,j}(A, B)=W_{i,j}(A, B)×Cᵢ;
selecting, in each information source document i, the largest competitiveness strength value Sᵢ(A, B) related to the first and second objects as follow: Sᵢ(A, B)=Max S_{i,j}(A, B); and
calculating, based on all information source documents that all relation instances stored in the relation instance repository belong to, the extensional competitiveness metric Sₒᵤₜ between the first and second objects as follow:
$${S}_{out} = {\sum }_{i = 1}^{N} {S}_{i} ( A , B ) / {\sum }_{i = 1}^{N} {S}_{i}^{′}$$
wherein N denotes the total number of the information source documents that all relation instances stored in the relation instance repository belong to, Sᵢ′ denotes the largest competitiveness strength value for all relation instances in the information source document i, A and B denotes the first and second objects respectively.

5. The method according to claim 3 or 4, wherein the extensional competitiveness metric Sₒᵤₜ between the first and second objects is calculated as:
$${S}_{out} = log {\sum }_{i = 1}^{N} {S}_{i} ( A , B ) / log {\sum }_{i = 1}^{N} {S}_{i}^{′} .$$

6. The method according to claim 1, wherein the relation instance further includes additional information, the method further comprises:
filtering the selected associated relation instances related to the first and second objects based on the additional information to select some of the associated relation instances whose additional information meets one or more predetermined conditions,
wherein the additional information is at least one of time information, area information and domain information.

7. The method according to claim 6, wherein the additional information is time information, and filtering the selected associated relation instances comprises selecting the associated relation instances related to the first and second objects during a specific period of time.

8. The method according to claim 6, wherein the additional information is area information, and filtering the selected associated relation instances comprises selecting the associated relation instances related to the first and second objects that conform to a specific area.

9. The method according to claim 6, wherein the additional information is domain information, and filtering the selected associated relation instances comprises selecting the associated relation instances related to the first and second objects that conform to a specific domain.

10. The method according to claim 1, further comprising:
calculating an intensional competitiveness metric Sᵢₙ between the first and second objects; and
combining the intensional competitiveness metric Sᵢₙ with the extensional competitiveness metric Sₒᵤₜ to derive an integrated competitiveness metric S as the competitiveness metric between the first and second objects.

11. The method according to claim 10, wherein the first and second objects have a first profile and a second profile, each composed of a plurality of attributes, respectively, and calculating the intensional competitiveness metric Sᵢₙ comprises:
normalizing the first profile and the second profile with reference to ontology information; and
calculating, based on the normalized first and second profiles, the intensional competitiveness metric Sᵢₙ between the first and second objects.

12. The method according to claim 10, wherein combining the intensional competitiveness metric Sᵢₙ with the extensional competitiveness metric Sₒᵤₜ comprises:
performing a data quality analysis on the selected associated relation instances related to the first and second objects to determine an integration strategy; and
calculating the integrated competitiveness metric S according to the determined integration strategy.

13. The method according to claim 12, wherein calculating the integrated competitiveness metric S comprises:
according to the determined integration strategy, obtaining an intensional weight coefficient Wᵢₙ and an extensional weight coefficient Wₒᵤₜ corresponding to the intensional competitiveness metric Sᵢₙ and the extensional competitiveness metric Sₒᵤₜ respectively; and
calculating the weighted sum of the intensional and extensional competitiveness metrics Sᵢₙ and Sₒᵤₜ as the integrated competitiveness metric S=Sᵢₙ×Wᵢₙ+Sₒᵤₜ×Wₒᵤₜ.

14. A system for calculating competitiveness metric between objects, comprising:
an object obtaining means for obtaining a first object and a second object;
a relation instance repository for storing relation instances;
a relation instance selection means for selecting, from all the relation instances stored in a relation instance repository, associated relation instances related to the first and second objects; and
an extensional competitiveness metric calculation means for calculating, based on the selected associated relation instances, an extensional competitiveness metric Sₒᵤₜ between the first and second objects as the competitiveness metric between the first and second objects.

15. The system according to claim 14, wherein the extensional competitiveness metric calculation means is configured for calculating a ratio of the number of information source documents that the associated relation instances related to the first and second objects belong to and the total number of information source documents that all relation instances stored in the relation instance repository belong to, as the extensional competitiveness metric Sₒᵤₜ between the first and second objects.

16. The system according to claim 14, wherein each of the selected associated relation instances related to the first and second objects belongs to different information source document, and the extensional competitiveness metric calculation means comprises:
a relation category determination unit for determining a relation category of each of the selected associated relation instances related to the first and second objects;
a competitiveness parameter selection unit for obtaining, based on the determined relation categories, a competitiveness strength coefficient Wᵢ(A, B) corresponding to each of the associated relation instances and a credibility value Cᵢ of an information source document that the associated relation instance belongs to, wherein i denotes the information source document the associated relation instance belongs to;
a competitiveness strength calculation unit for calculating, for each of the associated relation instances, a competitiveness strength value Sᵢ(A, B)=Wᵢ(A, B)×Cᵢ; and
an extensional competitiveness metric calculator for calculating, based on all information source documents that all relation instances stored in the relation instance repository belong to, the extensional competitiveness metric Sₒᵤₜ between the first and second objects as follow:
$${S}_{out} = {\sum }_{i = 1}^{N} {S}_{i} ( A , B ) / {\sum }_{i = 1}^{N} {S}_{i}^{′}$$
wherein N denotes the total number of the information source documents that all relation instances stored in the relation instance repository belong to, Sᵢ′ denotes the largest competitiveness strength value for all relation instances in the information source document i, A and B denotes the first and second objects respectively.

17. The system according to claim 14, wherein the respective associated relation instances related to the first and second objects can belong to the same information source document, and the extensional competitiveness metric calculation means comprises:
a relation category determination unit for determining a relation category of each of the selected associated relation instances related to the first and second objects;
a competitiveness parameter selection unit for obtaining, based on the determined relation categories, a competitiveness strength coefficient W_{i,j}(A, B) corresponding to each of the associated relation instances and a credibility value Cᵢ of an information source document that the associated relation instance belongs to, wherein i denotes the information source document the associated relation instance belongs to, and j denotes a reference number of the associated relation instance in the information source document i;
a competitiveness strength calculation unit for calculating, for each of the associated relation instances, a competitiveness strength value S_{i,j}(A, B)=W_{i,j}(A, B)×Cᵢ;
a largest strength selection unit for selecting, in each information source document i, the largest competitiveness strength value Sᵢ(A, B) related to the first and second objects as
$${S}_{i} ( A , B ) = {Max}_{j} {S}_{i , j} ( A , B ) ; and$$
an extensional competitiveness metric calculator for calculating, based on all information source documents that all relation instances stored in the relation instance repository belong to, the extensional competitiveness metric Sₒᵤₜ between the first and second objects as follow:
$${S}_{out} = {\sum }_{i = 1}^{N} {S}_{i} ( A , B ) / {\sum }_{i = 1}^{N} {S}_{i}^{′}$$
wherein N denotes the total number of the information source documents that all relation instances stored in the relation instance repository belong to, Sᵢ′ denotes the largest competitiveness strength value for all relation instances in the information source document i, A and B denotes the first and second objects respectively.

18. The system according to claim 16 or 17, wherein the extensional competitiveness metric calculator is configured for calculating the extensional competitiveness metric Sₒᵤₜ in the form of the following equation:
$${S}_{out} = log {\sum }_{i = 1}^{N} {S}_{i} ( A , B ) / log {\sum }_{i = 1}^{N} {S}_{i}^{′} .$$

19. The system according to claim 14, wherein the relation instance further includes additional information, the system further comprises:
a relation instance filter means coupled to the relation instance selection means for filtering the selected associated relation instances related to the first and second objects based on the additional information to select some of the associated relation instances whose additional information meets one or more predetermined conditions,
wherein the additional information is at least one of time information, area information and domain information.

20. The system according to claim 19, wherein the additional information is time information, and the relation instance filter means is configured for selecting the associated relation instances related to the first and second objects during a specific period of time.

21. The system according to claim 19, wherein the additional information is area information, and the relation instance filter means is configured for selecting the associated relation instances related to the first and second objects that conform to a specific area.

22. The system according to claim 19, wherein the additional information is domain information, and the relation instance filter means is configured for selecting the associated relation instances related to the first and second objects that conform to a specific domain.

23. The system according to claim 14, further comprising:
an intensional competitiveness metric calculation means for calculating an intensional competitiveness metric Sᵢₙ between the first and second objects; and
a combination means for combining the intensional competitiveness metric Sᵢₙ with the extensional competitiveness metric Sₒᵤₜ to derive an integrated competitiveness metric S as the competitiveness metric between the first and second objects.

24. The system according to claim 23, wherein the first and second objects have a first profile and a second profile, each composed of a plurality of attributes, respectively, and the intensional competitiveness metric calculation means comprises:
a ontology information base for storing ontology information;
a normalizing unit for normalizing the first profile and the second profile with reference to ontology information; and
an intensional competitiveness metric calculation unit for calculating, based on the normalized first and second profiles, the intensional competitiveness metric Sᵢₙ between the first and second objects.

25. The system according to claim 23, wherein the combination means further comprises:
a data quality analysis unit for performing a data quality analysis on the selected associated relation instances related to the first and second objects to determine an integration strategy; and
an integrated competitiveness metric calculator for calculating the integrated competitiveness metric S according to the determined integration strategy.

26. The system according to claim 25, wherein the integrated competitiveness metric calculator further comprises:
a weight coefficient obtaining unit for obtaining, according to the determined integration strategy, an intensional weight coefficient Wᵢₙ and an extensional weight coefficient Wₒᵤₜ corresponding to the intensional competitiveness metric Sᵢₙ and the extensional competitiveness metric Sₒᵤₜ respectively; and
an integrated competitiveness metric calculation unit for calculating the weighted sum of the intensional and extensional competitiveness metrics Sᵢₙ and Sₒᵤₜ as the integrated competitiveness metric S=Sᵢₙ×Wᵢₙ+Sₒᵤₜ×Wₒᵤₜ.
